(19) United States
(12) Patent Application Publication
(10) Pub. No.: US 2010/0020107 A1
(43) Pub. Date: Jan. 28, 2010

(54) Calibrating pixel elements

(75) Inventor: Clarence Chui, San Jose, CA (US)

Correspondence Address: VAN PELT, YI & JAMES LLP, 10050 N. FOOTHILL BLVD #200, CUPERTINO, CA, 95014, US

(73) Assignee: Boundary Net, Incorporated

(21) Appl. No.: 12/220,443

(22) Filed: Jul. 23, 2008

(51) Int. Cl. G09G 5/10

(52) U.S. Cl. 345/690

(57) ABSTRACT

A composite display is disclosed. In some embodiments, a composite display includes a paddle configured to sweep out an area, a plurality of pixel elements mounted on the paddle, and one or more optical sensors mounted on the paddle and configured to measure luminance values of the plurality of pixel elements. Selectively activating one or more of the plurality of pixel elements while the paddle sweeps the area causes at least a portion of an image to be rendered.

### BACKGROUND OF THE INVENTION

Digital displays are used to display images or video to provide advertising or other information. For example, digital displays may be used in billboards, bulletins, posters, highway signs, and stadium displays. Digital displays that use liquid crystal display (LCD) or plasma technologies are limited in size because of size limits of the glass panels associated with these technologies. Larger digital displays typically comprise a grid of printed circuit board (PCB) tiles, where each tile is populated with packaged light emitting diodes (LEDs). Because of the space required by the LEDs, the resolution of these displays is relatively coarse. Also, each LED corresponds to a pixel in the image, which can be expensive for large displays. In addition, a complex cooling system is typically used to sink heat generated by the LEDs, which may burn out at high temperatures. As such, improvements to digital display technology are needed.

### BRIEF DESCRIPTION OF THE DRAWINGS

Various embodiments of the invention are disclosed in the following detailed description and the accompanying drawings.

FIG. 1 is a diagram illustrating an embodiment of a composite display 100 having a single paddle.

FIG. 2A is a diagram illustrating an embodiment of a paddle used in a composite display.

FIG. 2B illustrates an example of temporal pixels in a sweep plane.

FIG. 3 is a diagram illustrating an embodiment of a composite display 300 having two paddles.

FIG. 4A illustrates examples of paddle installations in a composite display.

FIG. 4B is a diagram illustrating an embodiment of a composite display 410 that uses masks.

FIG. 4C is a diagram illustrating an embodiment of a composite display 430 that uses masks.

FIG. 5 is a block diagram illustrating an embodiment of a system for displaying an image.

FIG. 6A is a diagram illustrating an embodiment of a composite display 600 having two paddles.

FIG. 6B is a flowchart illustrating an embodiment of a process for generating a pixel map.

FIG. 7 illustrates examples of paddles arranged in various arrays.

FIG. 8 illustrates examples of paddles with coordinated in phase motion to prevent mechanical interference.

FIG. 9 illustrating examples of paddles with coordinated out of phase motion to prevent mechanical interference.

FIG. 10 is a diagram illustrating an example of a cross section of a paddle in a composite display.

FIG. 11A illustrates an embodiment of a paddle of a composite display.

FIG. 11B illustrates an embodiment of a paddle of a composite display.

FIG. 12A illustrates an example of a pass band of a broadband photodetector.

FIG. 12B illustrates an example of a spectral profile of a red LED.

FIG. 12C illustrates both the pass band of a broadband photodetector and a spectral profile of a red LED.

FIG. 12D illustrates an example of a spectral profile of a red LED that has experienced degradation in luminance and a pass band of a broadband photodetector.

FIG. 13 illustrates an embodiment of a process for calibrating a pixel element.

FIG. 14A illustrates an example of a pass band of a red-sensitive photodetector.

FIG. 14B illustrates both a pass band of a red-sensitive photodetector and a spectral profile of a red LED.

FIG. 14C illustrates an example of a spectral profile of a red LED that has experienced degradation in luminance and a pass band of a red-sensitive photodetector.

FIG. 14D illustrates an example of a color coordinate shift of a red LED and a pass band of a red-sensitive photodetector.

FIG. 14E illustrates an example of a spectral profile of a red LED that is being overdriven and a pass band of a red-sensitive photodetector.

FIG. 15 illustrates an embodiment of a paddle of a composite display.

FIG. 16 illustrates an embodiment of a paddle of a composite display.

FIG. 17 illustrates an embodiment of a process for calibrating the LEDs of a paddle.

FIG. 18A illustrates the pass bands of a photodetector.

FIG. 18B illustrates the pass bands of two photodetectors.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

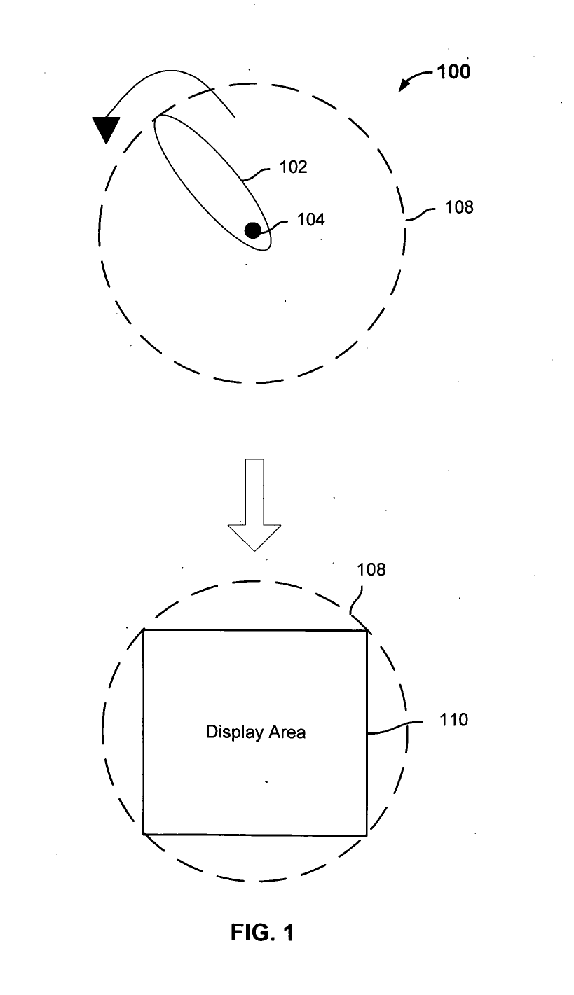

FIG. 1 is a diagram illustrating an embodiment of a composite display 100 having a single paddle. In the example shown, paddle 102 is configured to rotate at one end about axis of rotation 104 at a given frequency, such as 60 Hz. Paddle 102 sweeps out area 108 during one rotation or paddle cycle. A plurality of pixel elements, such as LEDs, is installed on paddle 102. As used herein, a pixel element refers to any element that may be used to display at least a portion of image information. As used herein, image or image information may include image, video, animation, slideshow, or any other visual information that may be displayed. Other examples of pixel elements include: laser diodes, phosphors, cathode ray tubes, liquid crystal, any transmissive or emissive optical modulator. Although LEDs may be described in the examples herein, any appropriate pixel elements may be used. In various embodiments, LEDS may be arranged on paddle 102 in a variety of ways, as more fully described below.

As paddle 102 sweeps out area 108, one or more of its LEDs are activated at appropriate times such that an image or a part thereof is perceived by a viewer who is viewing swept area 108. An image is comprised of pixels each having a spatial location. It can be determined at which spatial location a particular LED is at any given point in time. As paddle 102 rotates, each LED can be activated as appropriate when its location coincides with a spatial location of a pixel in the image. If paddle 102 is spinning fast enough, the eye perceives a continuous image. This is because the eye has a poor frequency response to luminance and color information. The eye integrates color that it sees within a certain time window. If a few images are flashed in a fast sequence, the eye integrates that into a single continuous image. This low temporal sensitivity of the eye is referred to as persistence of vision.

As such, each LED on paddle 102 can be used to display multiple pixels in an image. A single pixel in an image is mapped to at least one “temporal pixel” in the display area in composite display 100. A temporal pixel can be defined by a pixel element on paddle 102 and a time (or angular position of the paddle), as more fully described below.

The display area for showing the image or video may have any shape. For example, the maximum display area is circular and is the same as swept area 108. A rectangular image or video may be displayed within swept area 108 in a rectangular display area 110 as shown.

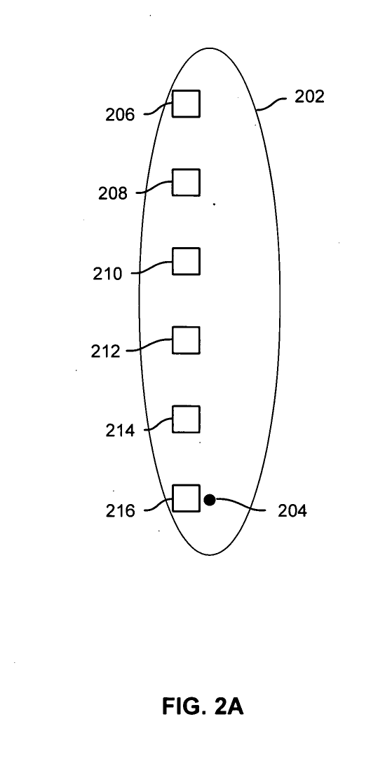

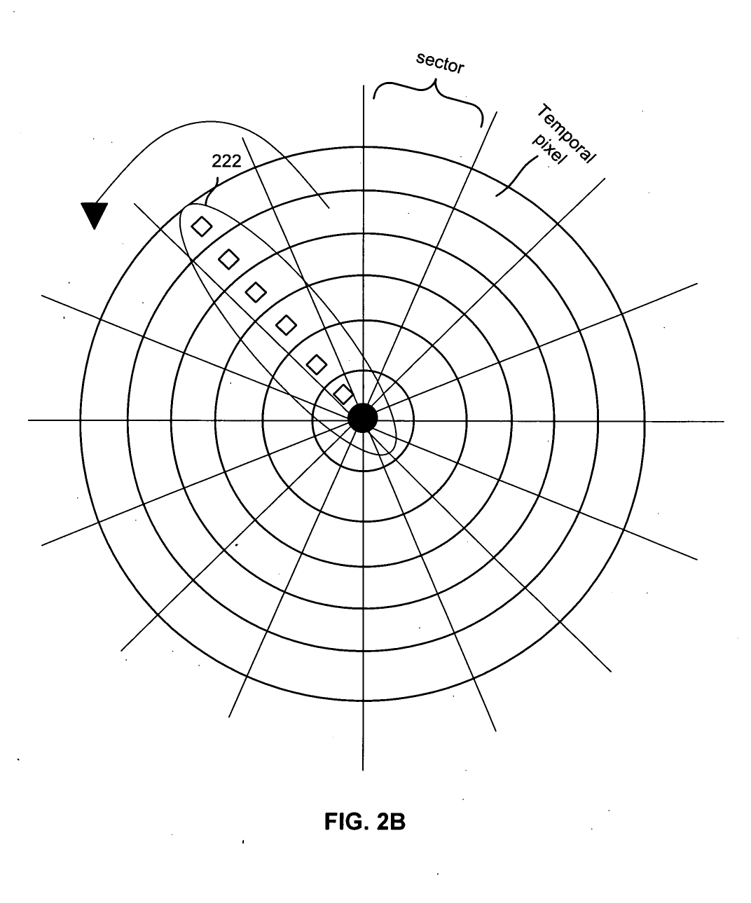

FIG. 2A is a diagram illustrating an embodiment of a paddle used in a composite display. For example, paddle 202, 302, or 312 (discussed later) may be similar to paddle 102. Paddle 202 is shown to include a plurality of LEDs 206-216 and an axis of rotation 204 about which paddle 202 rotates. LEDs 206-216 may be arranged in any appropriate way in various embodiments. In this example, LEDs 206-216 are arranged such that they are evenly spaced from each other and aligned along the length of paddle 202. They are aligned on the edge of paddle 202 so that LED 216 is adjacent to axis of rotation 204. This is so that as paddle 202 rotates, there is no blank spot in the middle (around axis of rotation 204). In some embodiments, paddle 202 is a PCB shaped like a paddle. In some embodiments, paddle 202 has an aluminum, metal, or other material casing for reinforcement.

FIG. 2B illustrates an example of temporal pixels in a sweep plane. In this example, each LED on paddle 222 is associated with an annulus (area between two circles) around the axis of rotation. Each LED can be activated once per sector (angular interval). Activating an LED may include, for example, turning on the LED for a prescribed time period (e.g., associated with a duty cycle) or turning off the LED. The intersections of the concentric circles and sectors form areas that correspond to temporal pixels. In this example, each temporal pixel has an angle of 42.5 degrees, so that there are a total of 16 sectors during which an LED may be turned on to indicate a pixel. Because there are 6 LEDs, there are 6*16=96 temporal pixels. In another example, a temporal pixel may have an angle of 1/10 of a degree, so that there are a total of 3600 angular positions possible.

Because the spacing of the LEDs along the paddle is uniform in the given example, temporal pixels get denser towards the center of the display (near the axis of rotation). Because image pixels are defined based on a rectangular coordinate system, if an image is overlaid on the display, one image pixel may correspond to multiple temporal pixels close to the center of the display. Conversely, at the outermost portion of the display, one image pixel may correspond to one or a fraction of a temporal pixel. For example, two or more image pixels may fit within a single temporal pixel. In some embodiments, the display is designed (e.g., by varying the sector time or the number/placement of LEDs on the paddle) so that at the outermost portion of the display, there is at least one temporal pixel per image pixel. This is to retain in the display the same level of resolution as the image. In some embodiments, the sector size is limited by how quickly LED control data can be transmitted to an LED driver to activate LED(s). In some embodiments, the arrangement of LEDs on the paddle is used to make the density of temporal pixels more uniform across the display. For example, LEDs may be placed closer together on the paddle the farther they are from the axis of rotation.

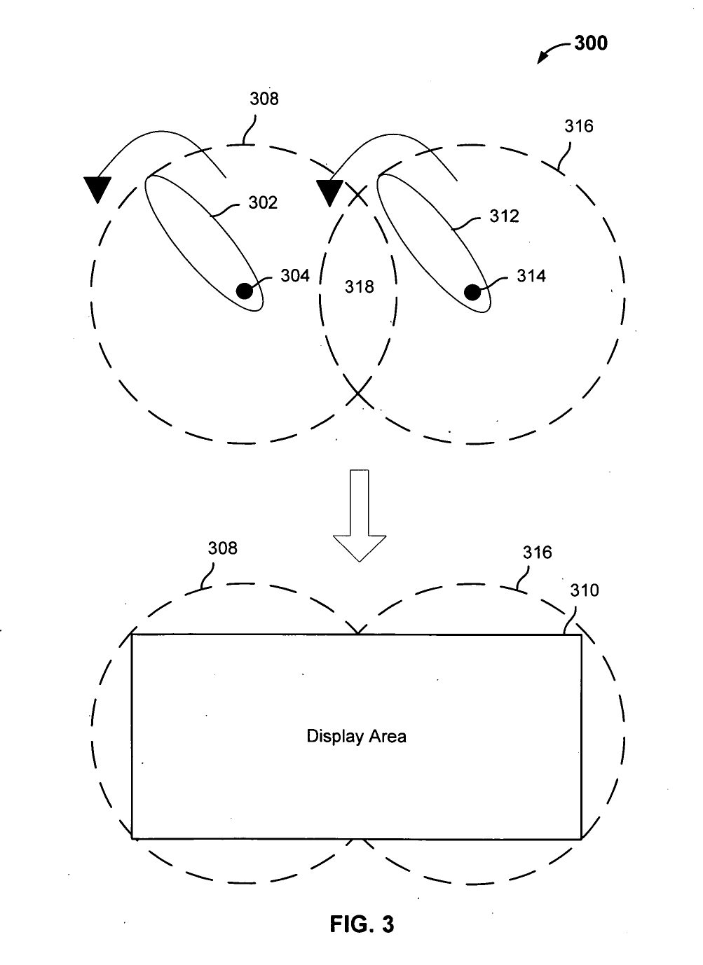

FIG. 3 is a diagram illustrating an embodiment of a composite display 300 having two paddles. In the example shown, paddle 302 is configured to rotate at one end about axis of rotation 304 at a given frequency, such as 60 Hz. Paddle 302 sweeps out area 308 during one rotation or paddle cycle. A plurality of pixel elements, such as LEDs, is installed on paddle 302. Paddle 312 is configured to rotate at one end about axis of rotation 314 at a given frequency, such as 60 Hz. Paddle 312 sweeps out area 316 during one rotation or paddle cycle. A plurality of pixel elements, such as LEDs, is installed on paddle 312. Swept areas 308 and 316 have an overlapping portion 318.

Using more than one paddle in a composite display may be desirable in order to make a larger display. For each paddle, it can be determined at which spatial location a particular LED is at any given point in time, so any image can be represented by a multiple paddle display in a manner similar to that described with respect to FIG. 1. In some embodiments, for overlapping portion 318, there will be twice as many LEDs passing through per cycle than in the nonoverlapping portions. This may make the overlapping portion of the display appear to the eye to have higher luminance. Therefore, in some embodiments, when an LED is in an overlapping portion, it may be activated half the time so that the whole display area appears to have the same luminance. This and other examples of handling overlapping areas are more fully described below.

The display area for showing the image or video may have any shape. The union of swept areas 308 and 316 is the maximum display area. A rectangular image or video may be displayed in rectangular display area 310 as shown.

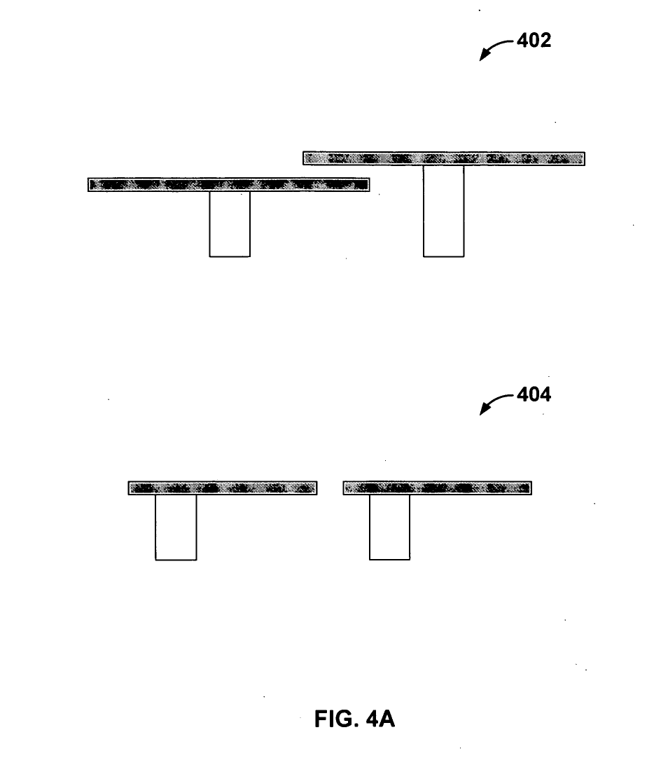

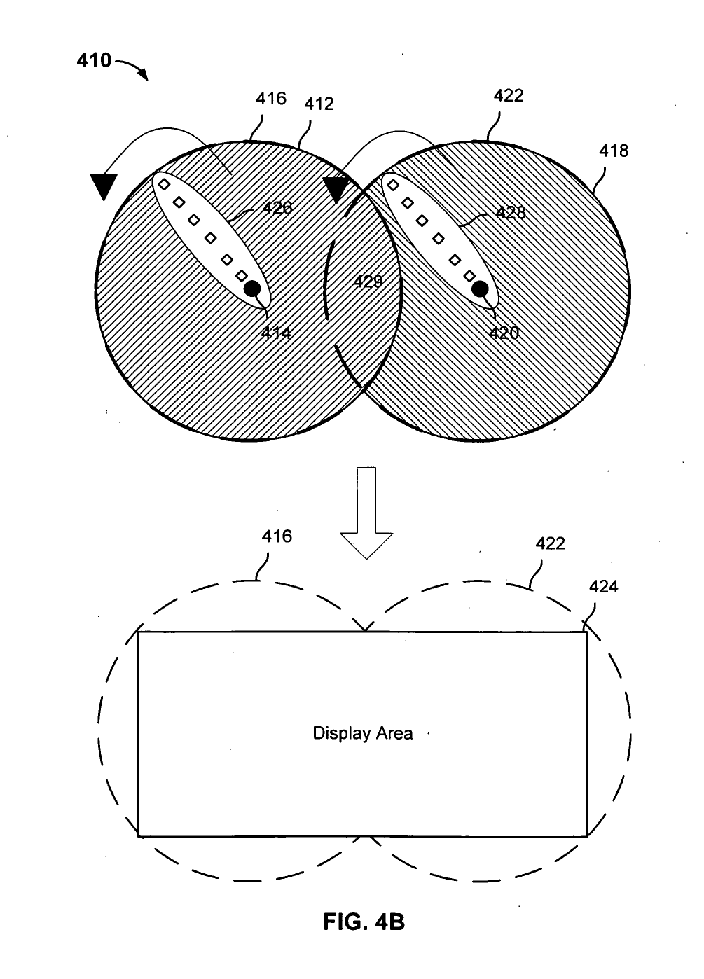

When using more than one paddle, there are various ways to ensure that adjacent paddles do not collide with each other. FIG. 4A illustrates examples of paddle installations in a composite display. In these examples, a cross section of adjacent paddles mounted on axes is shown.

In diagram 402, two adjacent paddles rotate in vertically separate sweep planes, ensuring that the paddles will not collide when rotating. This means that the two paddles can rotate at different speeds and do not need to be in phase with each other. To the eye, having the two paddles rotate in different sweep planes is not detectable if the resolution of the display is sufficiently smaller than the vertical spacing between the sweep planes. In this example, the axes are at the center of the paddles. This embodiment is more fully described below.

In diagram 404, the two paddles rotate in the same sweep plane. In this case, the rotation of the paddles is coordinated to avoid collision. For example, the paddles are rotated in phase with each other. Further examples of this are more fully described below.

In the case of the two paddles having different sweep planes, when viewing display area 310 from a point that is not normal to the center of display area 310, light may leak in diagonally between sweep planes. This may occur, for example, if the pixel elements emit unfocused light such that light is emitted at a range of angles. In some embodiments, a mask is used to block light from one sweep plane from being visible in another sweep plane. For example, a mask is placed behind paddle 302 and/or paddle 312. The mask may be attached to paddle 302 and/or 312 or stationary relative to paddle 302 and/or paddle 312. In some embodiments, paddle 302 and/or paddle 312 is shaped differently from that shown in FIGS. 3 and 4A, e.g., for masking purposes. For example, paddle 302 and/or paddle 312 may be shaped to mask the sweep area of the other paddle.

FIG. 4B is a diagram illustrating an embodiment of a composite display 410 that uses masks. In the example shown, paddle 426 is configured to rotate at one end about axis of rotation 414 at a given frequency, such as 60 Hz. A plurality of pixel elements, such as LEDs, is installed on paddle 426. Paddle 426 sweeps out area 416 (bold dashed line) during one rotation or paddle cycle. Paddle 428 is configured to rotate at one end about axis of rotation 420 at a given frequency, such as 60 Hz. Paddle 428 sweeps out area 422 (bold dashed line) during one rotation or paddle cycle. A plurality of pixel elements, such as LEDs, is installed on paddle 428.

In this example, mask 412 (solid line) is used behind paddle 426. In this case, mask 412 is the same shape as area 416 (i.e., a circle). Mask 412 masks light from pixel elements on paddle 428 from leaking into sweep area 416. Mask 412 may be installed behind paddle 426. In some embodiments, mask 412 is attached to paddle 426 and spins around axis of rotation 414 together with paddle 426. In some embodiments, mask 412 is installed behind paddle 426 and is stationary with respect to paddle 426. In this example, mask 418 (solid line) is similarly installed behind paddle 428.

In various embodiments, mask 412 and/or mask 418 may be made out of a variety of materials and have a variety of colors. For example, masks 412 and 418 may be black and made out of plastic.

The display area for showing the image or video may have any shape. The union of swept areas 416 and 422 is the maximum display area. A rectangular image or video may be displayed in rectangular display area 424 as shown.

Areas 416 and 422 overlap. As used herein, two elements (e.g., sweep area, sweep plane, mask, pixel element) overlap if they intersect in an x-y projection. In other words, if the areas are projected onto an x-y plane (defined by the x and y axes, where the x and y axes are in the plane of the figure), they intersect each other. Areas 416 and 422 do not sweep the same plane (do not have the same values of z, where the z axis is normal to the x and y axes), but they overlap each other in overlapping portion 429. In this example, mask 412 occludes sweep area 422 at overlapping portion 429 or occluded area 429. Mask 412 occludes sweep area 429 because it overlaps sweep area 429 and is on top of sweep area 429.

FIG. 4C is a diagram illustrating an embodiment of a composite display 430 that uses masks. In this example, pixel elements are attached to a rotating disc that functions as both a mask and a structure for the pixel elements. Disc 432 can be viewed as a circular shaped paddle. In the example shown, disc 432 (solid line) is configured to rotate at one end about axis of rotation 434 at a given frequency, such as 60 Hz. A plurality of pixel elements, such as LEDs, is installed on disc 432. Disc 432 sweeps out area 436 (bold dashed line) during one rotation or disc cycle. Disc 438 (solid line) is configured to rotate at one end about axis of rotation 440 at a given frequency, such as 60 Hz. Disc 438 sweeps out area 442 (bold dashed line) during one rotation or disc cycle. A plurality of pixel elements, such as LEDs, is installed on disc 438.

In this example, the pixel elements can be installed anywhere on discs 432 and 438. In some embodiments, pixel elements are installed on discs 432 and 438 in the same pattern. In other embodiments, different patterns are used on each disc. In some embodiments, the density of pixel elements is lower towards the center of each disc so the density of temporal pixels is more uniform than if the density of pixel elements is the same throughout the disc. In some embodiments, pixel elements are placed to provide redundancy of temporal pixels (i.e., more than one pixel is placed at the same radius). Having more pixel elements per pixel means that the rotation speed can be reduced. In some embodiments, pixel elements are placed to provide higher resolution of temporal pixels.

Disc 432 masks light from pixel elements on disc 438 from leaking into sweep area 436. In various embodiments, disc 432 and/or disc 438 may be made out of a variety of materials and have a variety of colors. For example, discs 432 and 438 may be black printed circuit board on which LEDs are installed.

The display area for showing the image or video may have any shape. The union of swept areas 436 and 442 is the maximum display area. A rectangular image or video may be displayed in rectangular display area 444 as shown.

Areas 436 and 442 overlap in overlapping portion 439. In this example, disc 432 occludes sweep area 442 at overlapping portion or occluded area 439.

In some embodiments, pixel elements are configured to not be activated when they are occluded. For example, the pixel elements installed on disc 438 are configured to not be activated when they are occluded, (e.g., overlap with occluded area 439). In some embodiments, the pixel elements are configured to not be activated in a portion of an occluded area. For example, an area within a certain distance from the edges of occluded area 439 is configured to not be activated. This may be desirable in case a viewer is to the left or right of the center of the display area and can see edge portions of the occluded area.

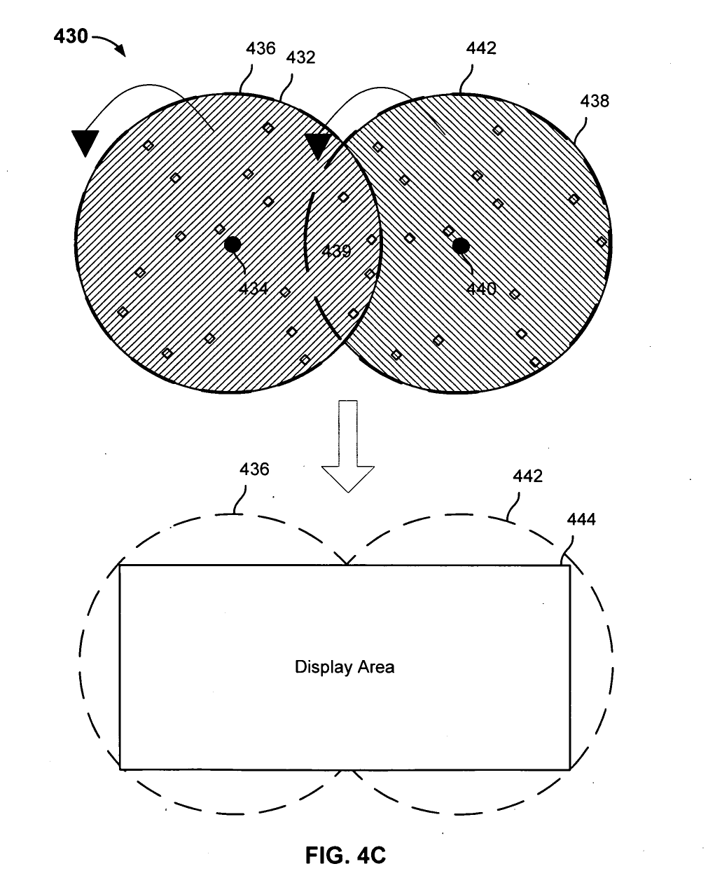

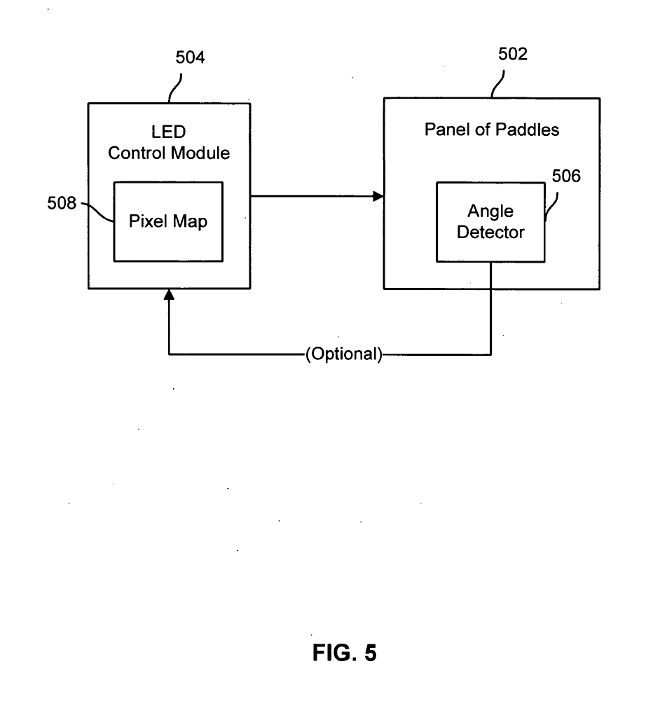

FIG. 5 is a block diagram illustrating an embodiment of a system for displaying an image. In the example shown, panel of paddles 502 is a structure comprising one or more paddles. As more fully described below, panel of paddles 502 may include a plurality of paddles, which may include paddles of various sizes, lengths, and widths; paddles that rotate about a midpoint or an endpoint; paddles that rotate in the same sweep plane or in different sweep planes; paddles that rotate in phase or out of phase with each other; paddles that have multiple arms; and paddles that have other shapes. Panel of paddles 502 may include all identical paddles or a variety of different paddles. The paddles may be arranged in a grid or in any other arrangement. In some embodiments, the panel includes angle detector 506, which is used to detect angles associated with one or more of the paddles. In some embodiments, there is an angle detector for each paddle on panel of paddles 502. For example, an optical detector may be mounted near a paddle to detect its current angle.

LED control module 504 is configured to optionally receive current angle information (e.g., angle(s) or information associated with angle(s)) from angle detector 506. LED control module 504 uses the current angles to determine LED control data to send to panel of paddles 502. The LED control data indicates which LEDs should be activated at that time (sector). In some embodiments, LED control module 504 determines the LED control data using pixel map 508. In some embodiments, LED control module 504 takes an angle as input and outputs which LEDs on a paddle should be activated at that sector for a particular image. In some embodiments, an angle is sent from angle detector 506 to LED control module 504 for each sector (e.g., just prior to the paddle reaching the sector). In some embodiments, LED control data is sent from LED control module 504 to panel of paddles 502 for each sector.

In some embodiments, pixel map 508 is implemented using a lookup table, as more fully described below. For different images, different lookup tables are used. Pixel map 508 is more fully described below.

In some embodiments, there is no need to read an angle using angle detector 506. Because the angular velocity of the paddles and an initial angle of the paddles (at that angular velocity) can be predetermined, it can be computed at what angle a paddle is at any given point in time. In other words, the angle can be determined based on the time. For example, if the angular velocity is ω, the angular location after time t is θᵢₙᵢₜᵢₐₗ+ωt where θᵢₙᵢₜᵢₐₗ is an initial angle once the paddle is spinning at steady state. As such, LED control module can serially output LED control data as a function of time (e.g., using a clock), rather than use angle measurements output from angle detector 506. For example, a table of time (e.g., clock cycles) versus LED control data can be built.

In some embodiments, when a paddle is starting from rest, it goes through a start up sequence to ramp up to the steady state angular velocity. Once it reaches the angular velocity, an initial angle of the paddle is measured in order to compute at what angle the paddle is at any point in time (and determine at what point in the sequence of LED control data to start).

In some embodiments, angle detector 506 is used periodically to provide adjustments as needed. For example, if the angle has drifted, the output stream of LED control data can be shifted. In some embodiments, if the angular speed has drifted, mechanical adjustments are made to adjust the speed.

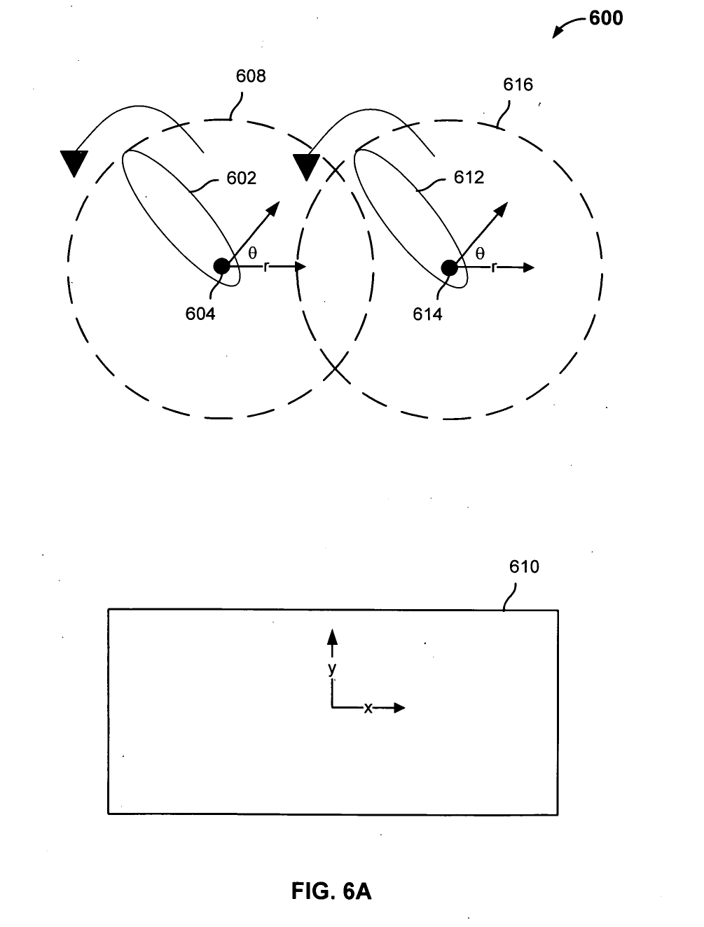

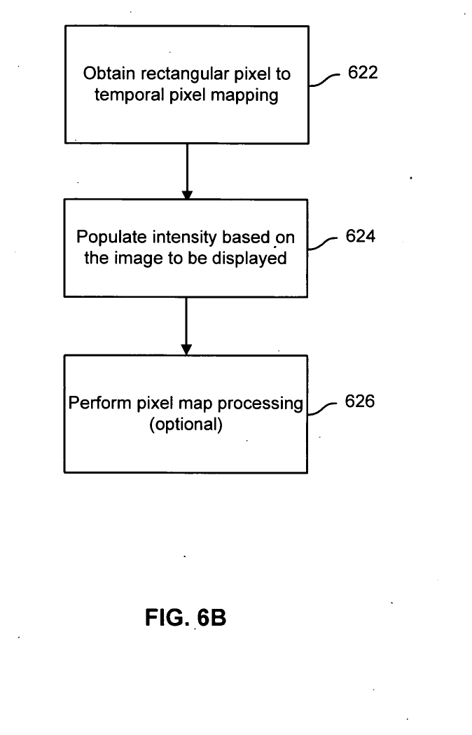

FIG. 6A is a diagram illustrating an embodiment of a composite display 600 having two paddles. In the example shown, a polar coordinate system is indicated over each of areas 608 and 616, with an origin located at each axis of rotation 604 and 614. In some implementations, the position of each LED on paddles 602 and 612 is recorded in polar coordinates. The distance from the origin to the LED is the radius r. The paddle angle is θ. For example, if paddle 602 is in the 3 o'clock position, each of the LEDs on paddle 602 is at 0 degrees. If paddle 602 is in the 12 o'clock position, each of the LEDs on paddle 602 is at 90 degrees. In some embodiments, an angle detector is used to detect the current angle of each paddle. In some embodiments, a temporal pixel is defined by P, r, and θ, where P is a paddle identifier and (r, θ) are the polar coordinates of the LED.

A rectangular coordinate system is indicated over an image 610 to be displayed. In this example, the origin is located at the center of image 610, but it may be located anywhere depending on the implementation. In some embodiments, pixel map 508 is created by mapping each pixel in image 610 to one or more temporal pixels in display area 608 and 616. Mapping may be performed in various ways in various embodiments.

FIG. 6B is a flowchart illustrating an embodiment of a process for generating a pixel map. For example, this process may be used to create pixel map 508. At 622, an image pixel to temporal pixel mapping is obtained. In some embodiments, mapping is performed by overlaying image 610 (with its rectangular grid of pixels (x, y) corresponding to the resolution of the image) over areas 608 and 616 (with their two polar grids of temporal pixels (r, θ), e.g., see FIG. 2B). For each image pixel (x, y), it is determined which temporal pixels are within the image pixel. The following is an example of a pixel map:

TABLE 1

| Image pixel (x, y) | Temporal Pixel (P, r, θ) | Intensity (f) |
|---|---|---|
| (a1, a2) | (b1, b2, b3) | |
| (a3, a4) | (b4, b5, b6); (b7, b8, b9) | |
| (a5, a6) | (b10, b11, b12) | |
| etc. | etc. | |

As previously stated, one image pixel may map to multiple temporal pixels as indicated by the second row. In some embodiments, instead of r, an index corresponding to the LED is used. In some embodiments, the image pixel to temporal pixel mapping is precomputed for a variety of image sizes and resolutions (e.g., that are commonly used).

At 624, an intensity f is populated for each image pixel based on the image to be displayed. In some embodiments, f indicates whether the LED should be on (e.g., 1) or off (e.g., 0). For example, in a black and white image (with no grayscale), black pixels map to f=1 and white pixels map to f=0. In some embodiments, f may have fractional values. In some embodiments, f is implemented using duty cycle management. For example, when f is 0, the LED is not activated for that sector time. When f is 1, the LED is activated for the whole sector time. When f is 0.5, the LED is activated for half the sector time. In some embodiments, f can be used to display grayscale images. For example, if there are 256 gray levels in the image, pixels with gray level 128 (half luminance) would have f=0.5. In some embodiments, rather than implement f using duty cycle (i.e., pulse width modulated), f is implemented by adjusting the current to the LED (i.e., pulse height modulation).

For example, after the intensity f is populated, the table may appear as follows:

TABLE 2

| Image pixel (x, y) | Temporal Pixel (P, r, θ) | Intensity (f) |
|---|---|---|
| (a1, a2) | (b1, b2, b3) | f1 |
| (a3, a4) | (b4, b5, b6); (b7, b8, b9) | f2 |
| (a5, a6) | (b10, b11, b12) | f3 |
| etc. | etc. | etc. |

At 626, optional pixel map processing is performed. This may include compensating for overlap areas, balancing luminance in the center (i.e., where there is a higher density of temporal pixels), balancing usage of LEDs, etc. For example, when LEDs are in an overlap area (and/or on a boundary of an overlap area), their duty cycle may be reduced. For example, in composite display 300, when LEDs are in overlap area 318, their duty cycle is halved. In some embodiments, there are multiple LEDs in a sector time that correspond to a single image pixel, in which case, fewer than all the LEDs may be activated (i.e., some of the duty cycles may be set to 0). In some embodiments, the LEDs may take turns being activated (e.g., every N cycles where N is an integer), e.g., to balance usage so that one doesn't burn out earlier than the others. In some embodiments, the closer the LEDs are to the center (where there is a higher density of temporal pixels), the lower their duty cycle.

For example, after luminance balancing, the pixel map may appear as follows:

TABLE 3

| Image pixel (x, y) | Temporal Pixel (P, r, θ) | Intensity (f) |
|---|---|---|
| (a1, a2) | (b1, b2, b3) | f1 |
| (a3, a4) | (b4, b5, b6) | f2 |
| (a5, a6) | (b10, b11, b12) | f3 |
| etc. | etc. | etc. |

As shown, in the second row, the second temporal pixel was deleted in order to balance luminance across the pixels. This also could have been accomplished by halving the intensity to f2/2. As another alternative, temporal pixel (b4, b5, b6) and (b7, b8, b9) could alternately turn on between cycles. In some embodiments, this can be indicated in the pixel map. The pixel map can be implemented in a variety of ways using a variety of data structures in different implementations.

For example, in FIG. 5, LED control module 504 uses the temporal pixel information (P, r, θ, and f) from the pixel map. LED control module 504 takes θ as input and outputs LED control data P, r, and f. Panel of paddles 502 uses the LED control data to activate the LEDs for that sector time. In some embodiments, there is an LED driver for each paddle that uses the LED control data to determine which LEDs to turn on, if any, for each sector time.

Any image (including video) data may be input to LED control module 504. In various embodiments, one or more of 622, 624, and 626 may be computed live or in real time, i.e., just prior to displaying the image. This may be useful for live broadcast of images, such as a live video of a stadium. For example, in some embodiments, 622 is precomputed and 624 is computed live or in real time. In some implementations, 626 may be performed prior to 622 by appropriately modifying the pixel map. In some embodiments, 622, 624, and 626 are all precomputed. For example, advertising images may be precomputed since they are usually known in advance.

The process of FIG. 6B may be performed in a variety of ways in a variety of embodiments. Another example of how 622 may be performed is as follows. For each image pixel (x, y), a polar coordinate is computed. For example, (the center of) the image pixel is converted to polar coordinates for the sweep areas it overlaps with (there may be multiple sets of polar coordinates if the image pixel overlaps with an overlapping sweep area). The computed polar coordinate is rounded to the nearest temporal pixel. For example, the temporal pixel whose center is closest to the computed polar coordinate is selected. (If there are multiple sets of polar coordinates, the temporal pixel whose center is closest to the computed polar coordinate is selected.) This way, each image pixel maps to at most one temporal pixel. This may be desirable because it maintains a uniform density of activated temporal pixels in the display area (i.e., the density of activated temporal pixels near an axis of rotation is not higher than at the edges). For example, instead of the pixel map shown in Table 1, the following pixel map may be obtained:

TABLE 4

| Image pixel (x, y) | Temporal Pixel (P, r, θ) | Intensity (f) |
|---|---|---|
| (a1, a2) | (b1, b2, b3) | |
| (a3, a4) | (b7, b8, b9) | |
| (a5, a6) | (b10, b11, b12) | |
| etc. | etc. | |

In some cases, using this rounding technique, two image pixels may map to the same temporal pixel. In this case, a variety of techniques may be used at 626, including, for example: averaging the intensity of the two rectangular pixels and assigning the average to the one temporal pixel; alternating between the first and second rectangular pixel intensities between cycles; remapping one of the image pixel to a nearest neighbor temporal pixel; etc.

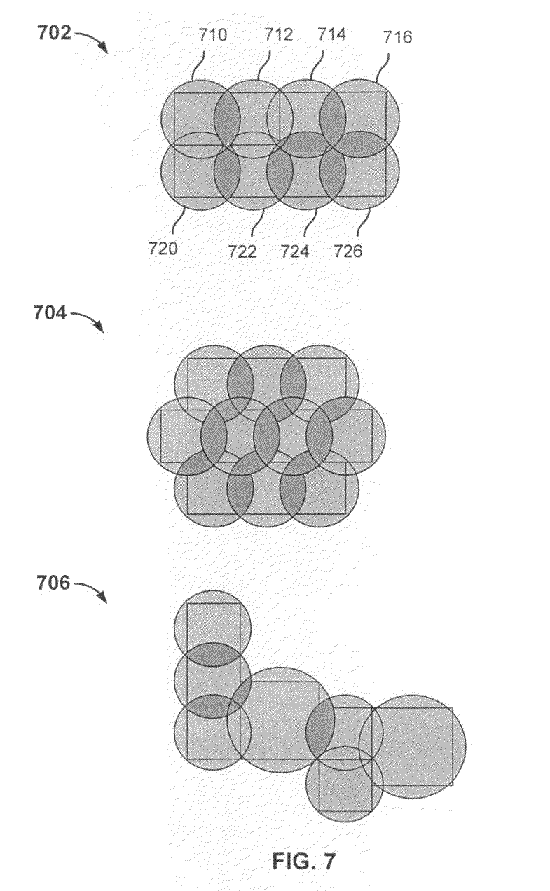

FIG. 7 illustrates examples of paddles arranged in various arrays. For example, any of these arrays may comprise panel of paddles 502. Any number of paddles may be combined in an array to create a display area of any size and shape.

Arrangement 702 shows eight circular sweep areas corresponding to eight paddles each with the same size. The sweep areas overlap as shown. In addition, rectangular display areas are shown over each sweep area. For example, the maximum rectangular display area for this arrangement would comprise the union of all the rectangular display areas shown. To avoid having a gap in the maximum display area, the maximum spacing between axes of rotation is \sqrt{2}R, where R is the radius of one of the circular sweep areas. The spacing between axes is such that the periphery of one sweep area does not overlap with any axes of rotation, otherwise there would be interference. Any combination of the sweep areas and rectangular display areas may be used to display one or more images.

In some embodiments, the eight paddles are in the same sweep plane. In some embodiments, the eight paddles are in different sweep planes. It may be desirable to minimize the number of sweep planes used. For example, it is possible to have every other paddle sweep the same sweep plane. For example, sweep areas 710, 714, 722, and 726 can be in the same sweep plane, and sweep areas 712, 716, 720, and 724 can be in another sweep plane.

In some configurations, sweep areas (e.g., sweep areas 710 and 722) overlap each other. In some configurations, sweep areas are tangent to each other (e.g., sweep areas 710 and 722 can be moved apart so that they touch at only one point). In some configurations, sweep areas do not overlap each other (e.g., sweep areas 710 and 722 have a small gap between them), which is acceptable if the desired resolution of the display is sufficiently low.

Arrangement 704 shows ten circular sweep areas corresponding to ten paddles. The sweep areas overlap as shown. In addition, rectangular display areas are shown over each sweep area. For example, three rectangular display areas, one in each row of sweep areas, may be used, for example, to display three separate advertising images. Any combination of the sweep areas and rectangular display areas may be used to display one or more images.

Arrangement 706 shows seven circular sweep areas corresponding to seven paddles. The sweep areas overlap as shown. In addition, rectangular display areas are shown over each sweep area. In this example, the paddles have various sizes so that the sweep areas have different sizes. Any combination of the sweep areas and rectangular display areas may be used to display one or more images. For example, all the sweep areas may be used as one display area for a non-rectangular shaped image, such as a cut out of a giant serpent.

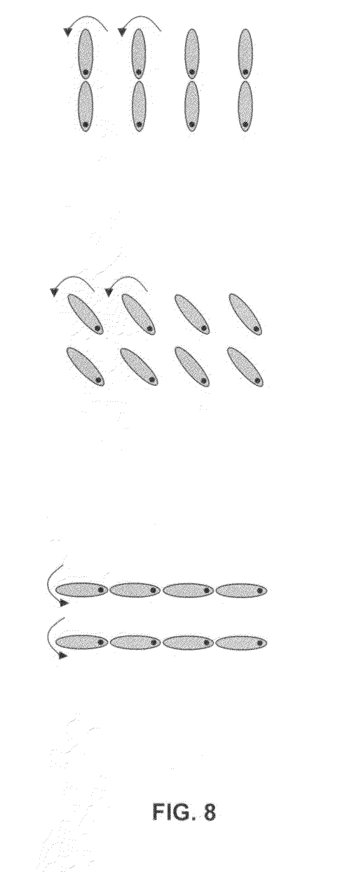

FIG. 8 illustrates examples of paddles with coordinated in phase motion to prevent mechanical interference. In this example, an array of eight paddles is shown at three points in time. The eight paddles are configured to move in phase with each other; that is, at each point in time, each paddle is oriented in the same direction (or is associated with the same angle when using the polar coordinate system described in FIG. 6A).

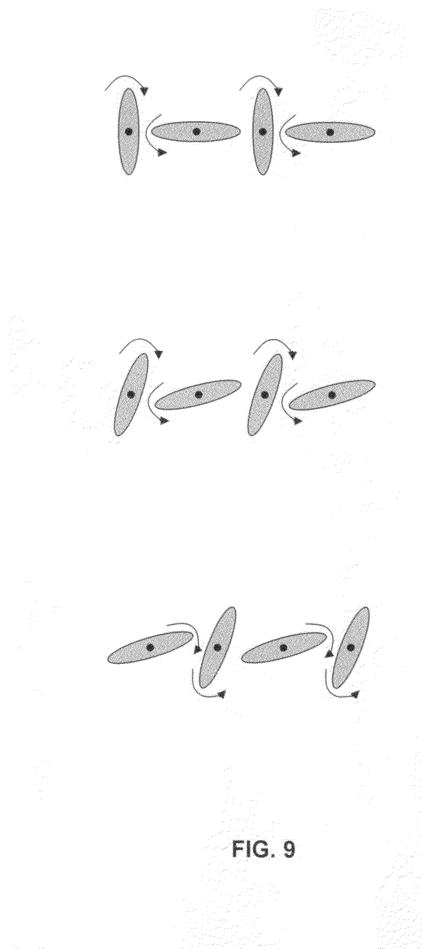

FIG. 9 illustrating examples of paddles with coordinated out of phase motion to prevent mechanical interference. In this example, an array of four paddles is shown at three points in time. The four paddles are configured to move out of phase with each other; that is, at each point in time, at least one paddle is not oriented in the same direction (or is associated with the same angle when using the polar coordinate system described in FIG. 6A) as the other paddles. In this case, even though the paddles move out of phase with each other, their phase difference (difference in angles) is such that they do not mechanically interfere with each other.

The display systems described herein have a naturally built in cooling system. Because the paddles are spinning, heat is naturally drawn off of the paddles. The farther the LED is from the axis of rotation, the more cooling it receives. In some embodiments, this type of cooling is at least 10× effective as systems in which LED tiles are stationary and in which an external cooling system is used to blow air over the LED tiles using a fan. In addition, a significant cost savings is realized by not using an external cooling system.

Although in the examples herein, the image to be displayed is provided in pixels associated with rectangular coordinates and the display area is associated with temporal pixels described in polar coordinates, the techniques herein can be used with any coordinate system for either the image or the display area.

Although rotational movement of paddles is described herein, any other type of movement of paddles may also be used. For example, a paddle may be configured to move from side to side (producing a rectangular sweep area, assuming the LEDs are aligned in a straight row). A paddle may be configured to rotate and simultaneously move side to side (producing an elliptical sweep area). A paddle may have arms that are configured to extend and retract at certain angles, e.g., to produce a more rectangular sweep area. Because the movement is known, a pixel map can be determined, and the techniques described herein can be applied.

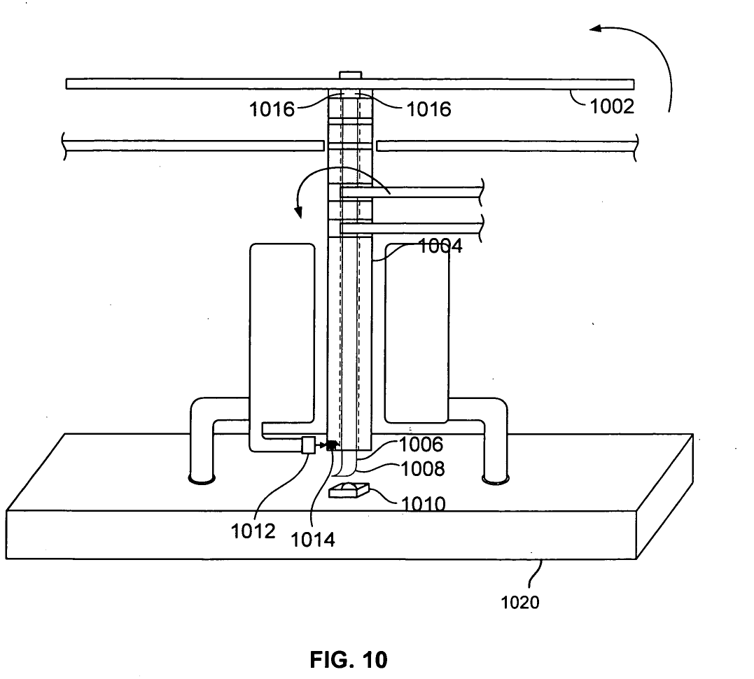

FIG. 10 is a diagram illustrating an example of a cross section of a paddle in a composite display. This example is shown to include paddle 1002, shaft 1004, optical fiber 1006, optical camera 1012, and optical data transmitter 1010. Paddle 1002 is attached to shaft 1004. Shaft 1004 is bored out (i.e., hollow) and optical fiber 1006 runs through its center. The base 1008 of optical fiber 1006 receives data via optical data transmitter 1010. The data is transmitted up optical fiber 1006 and transmitted at 1016 to an optical detector (not shown) on paddle 1002. The optical detector provides the data to one or more LED drivers used to activate one or more LEDs on paddle 1002. In some embodiments, LED control data that is received from LED control module 504 is transmitted to the LED driver in this way.

In some embodiments, the base of shaft 1004 has appropriate markings 1014 that are read by optical camera 1012 to determine the current angular position of paddle 1002. In some embodiments, optical camera 1012 is used in conjunction with angle detector 506 to output angle information that is fed to LED control module 508 as shown in FIG. 5.

The performance of a pixel element comprising a composite display may degrade as it ages. Degradation of a pixel element is manifest in two forms: a decrease in the intensity or luminance of the pixel element over time and/or a color coordinate shift in the spectral profile of the pixel element over time. In some cases, a reduction in luminance (i.e., the pixel element becoming dimmer) is a first order effect of degradation, and a shift in the spectrum of the pixel element is a second order effect. As described further below, a paddle of a composite display may include one or more components that aid in detecting degradation of pixel elements so that the pixel elements of the composite display can be periodically calibrated to at least in part correct for and/or ameliorate degradation in performance.

In some embodiments, one or more optical sensors (e.g., photodetectors, photodiodes, etc.) are installed on each paddle of a composite display and are employed to measure the intensity or luminance of light emitted by the pixel elements on the paddle. Although photodetectors may be described in the examples herein, any appropriate optical sensors may be employed. The types of photodetectors installed on a paddle depend on the types of pixel element degradations desired to be detected and corrected for. For example, in the cases in which only the first order effects of pixel element degradation (i.e., reductions in luminance) are desired to be detected, broadband photodetectors may be sufficient. However, if color coordinate shifts are also desired to be detected, red-sensitive, green-sensitive, and/or blue-sensitive photodetectors may additionally be needed. As further described below, in various embodiments, a portion of the light emitted by a pixel element may be reflected back by a structure used to protect the front surface of the composite display and received by a corresponding photodetector, or a portion of the light emitted by a pixel element may be focused by a custom lenslet attached to the pixel element in the direction of a corresponding photodetector. The photodetectors installed on a paddle may initially be employed to measure baseline luminance values when the pixel elements are calibrated during manufacturing or set-up. In some embodiments, other pixel elements (e.g., nearby pixel elements or all pixel elements on the paddle) are turned off while the baseline luminance value of a pixel element is determined. During subsequent calibrations in the field, the photodetectors may be employed to measure current luminance values of the pixel elements. The current luminance values of the pixel elements can be compared with associated baseline luminance values measured when the pixel elements were initially calibrated. The currents driving the pixel elements can be appropriately adjusted during in field calibrations to restore the luminance values of the pixel elements to their baseline values if they have degraded. The current luminance values of the pixel elements can also be employed to detect color shifts. A color shift can be corrected, for example, by overdriving one or more pixel elements associated with a color that is deficient and underdriving one or more pixel elements associated with a color that is excessive to rebalance the colors.

FIG. 11A illustrates an embodiment of a paddle of a composite display. Paddle 1100 comprises a PCB disc that rotates about axis of rotation 1102. Pixel elements are radially mounted on paddle 1100 and in the given example are depicted by small squares. Photodetectors are also mounted on paddle 1100 and in the given example are depicted by small circles. In various embodiments, each photodetector may be associated with measuring the intensity or luminance of any number of pixel elements. For instance, in some embodiments, each photodetector installed on a paddle is associated with a set of 5-10 radially adjacent pixel elements. In the example of FIG. 11A, each photodetector is associated with a set of five radially adjacent pixel elements. For example, photodetector 1104 is associated with measuring the luminance of each of pixel elements 1106. A portion of the light emitted by each pixel element in set 1106 is reflected back towards and/or otherwise received by photodetector 1104. The intensity or luminance of each pixel element in set 1106 as measured by photodetector 1104 depends at least in part on the distance and/or angle of the pixel element from photodetector 1104, with a lower intensity measured for pixel elements that are situated farther away. Thus, when the pixel elements of paddle 1100 are calibrated during manufacturing, different baseline luminance values may be measured for each pixel element in set 1106 by associated photodetector 1104 based on the distance and/or angle of the pixel element from the photodetector. In the cases in which only reductions in luminance of pixel elements are desired to be detected and corrected, the photodetectors may comprise broadband photodetectors. For example, in the cases in which the pixel elements comprise white LEDs, degradation in an LED may at least primarily result in a reduction in luminance of the LED. In such cases, broadband photodetectors can be employed to periodically measure the luminance values of the LEDs, and if an LED is found to have a lower luminance than its baseline value, the current supplied to the LED can be appropriately increased to return the luminance of the LED to its baseline value. In some embodiments, the pixel elements of paddle 1100 may comprise color LEDs, i.e., red, green, and/or blue LEDs. FIG. 11B illustrates an embodiment in which each array of pixel elements of paddle 1100 comprises either red (R), green (G), or blue (B) LEDs. In such cases, broadband photodetectors may be employed as well if only reductions in luminance are desired to be detected and corrected.

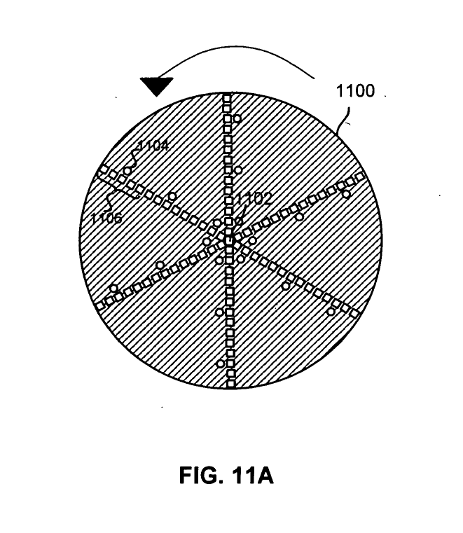

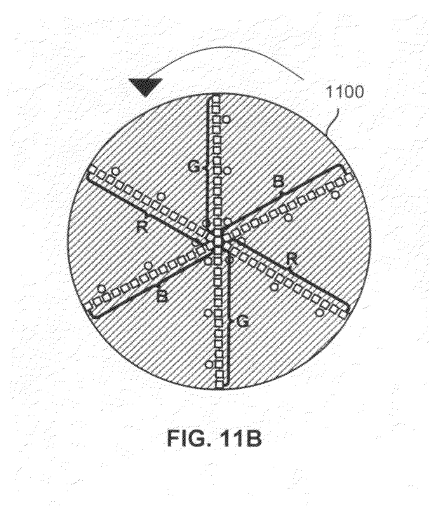

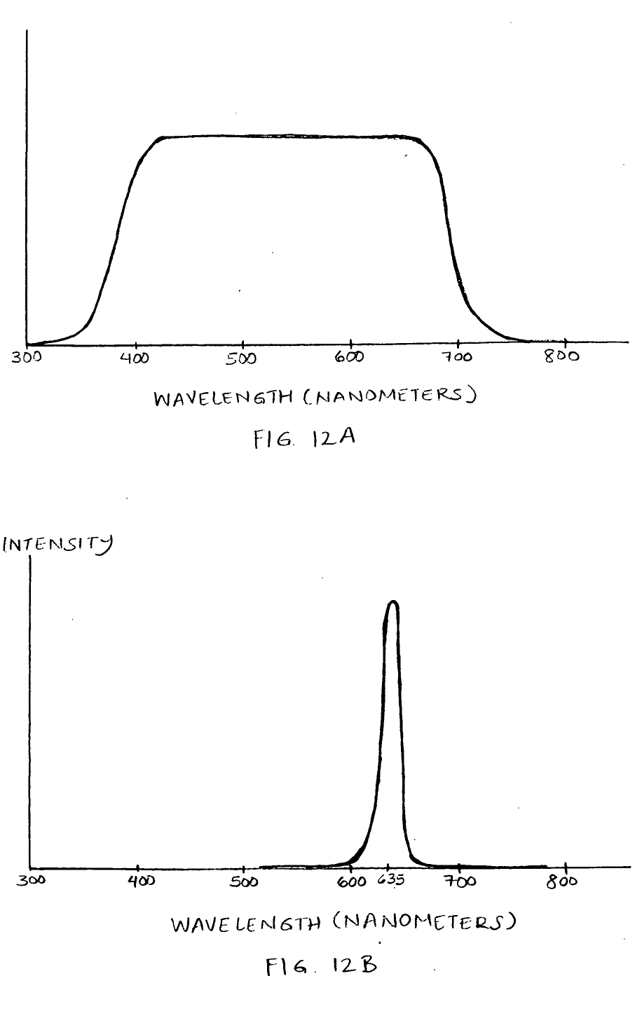

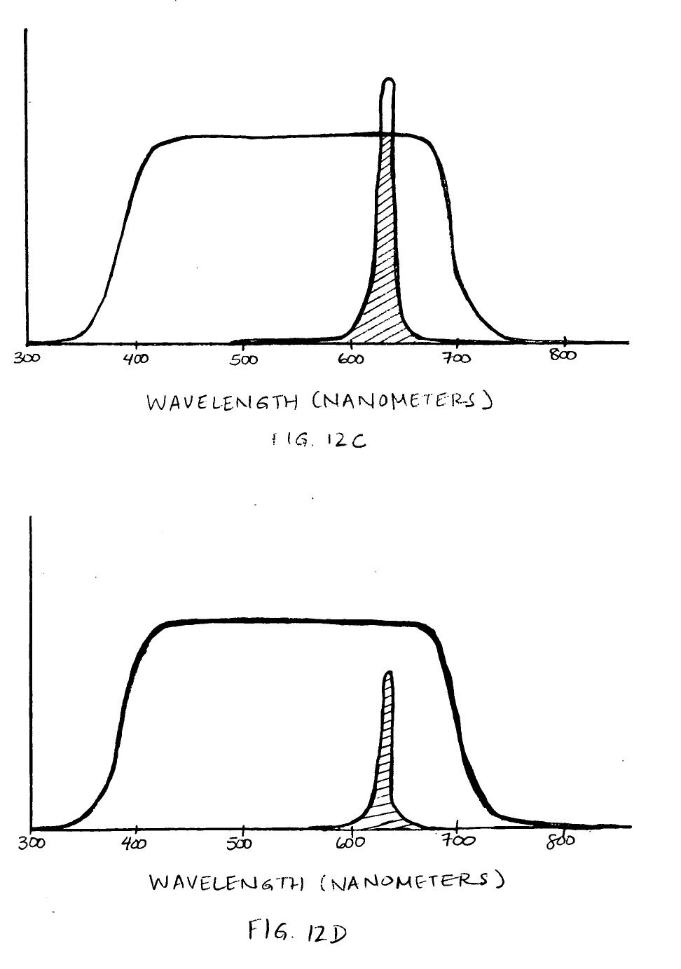

FIG. 12A illustrates an example of a pass band of a broadband photodetector, which is ideally equally sensitive to (i.e., able to detect) luminance from all wavelengths of light. FIG. 12B illustrates an example of a spectral profile of a red LED. As depicted, the profile is centered around a wavelength of 635 nm. FIG. 12C illustrates both the pass band of the broadband photodetector of FIG. 12A and the spectral profile of the red LED of FIG. 12B. In some embodiments, the luminance of the red LED is determined from the shaded area of FIG. 12C, i.e., the portion of the spectral profile of the red LED captured by the photodetector. FIG. 12D illustrates an example of the spectral profile of a red LED that has experienced degradation in luminance and the pass band of the broadband photodetector. As depicted,, a smaller area is captured by the photodetector in FIG. 12D relative to the area of FIG. 12C. Such a reduction in luminance can be corrected by increasing the current that is driving the LED so that the luminance of the LED is restored to its baseline value, e.g., as depicted in FIGS. 12B and 12C.

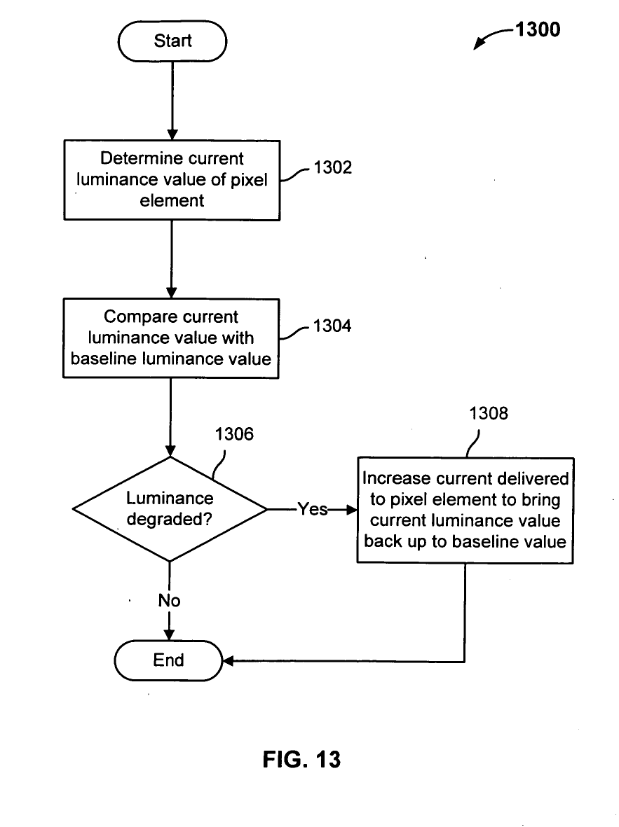

FIG. 13 illustrates an embodiment of a process for calibrating a pixel element. In some embodiments, process 1300 is employed to correct for a decrease in luminance of a pixel element which may result, for example, from aging of the pixel element. Process 1300 starts at 1302 at which a current luminance value of a particular pixel element is determined. For example, the current luminance value of the pixel element may be determined from an intensity value measured by a photodetector associated with the pixel element. At 1304, the current luminance value of the pixel element determined at 1302 is compared with a baseline luminance value of the pixel element that is determined and stored during an initial calibration of the associated composite display, e.g., during manufacturing or set-up. At 1306, it is determined if the current luminance value of the pixel element has degraded relative to its baseline value. If it is determined at 1306 that the current luminance value of the pixel element has not degraded relative to its baseline value, process 1300 ends since calibration to correct for a reduction in luminance is not needed. If it is determined at 1306 that the current luminance value of the pixel element has degraded relative to its baseline value (i.e., the current luminance value is less than its baseline value, e.g., by a prescribed amount), the current driving the pixel element is increased to bring the current luminance value of the pixel element back up to its baseline value, and process 1300 subsequently ends. In some embodiments, process 1300 is employed for each of at least a subset of pixel elements of a composite display during calibration.

As described, a reduction in luminance, i.e., a pixel element becoming dimmer, may be one effect of degradation in performance. In some cases, a color coordinate shift, including a shift in the peak wavelength emitted by the pixel element, may be another effect of degradation in performance. If only reductions in luminance or brightness of pixel elements are desired to be detected and corrected, broadband photodetectors may be sufficient as described. In some embodiments, it is desirable to detect changes in the chromaticity of the pixel elements. For example, if a composite display comprises color LEDs, color coordinate shifts may occur, for example, as the LEDs age.

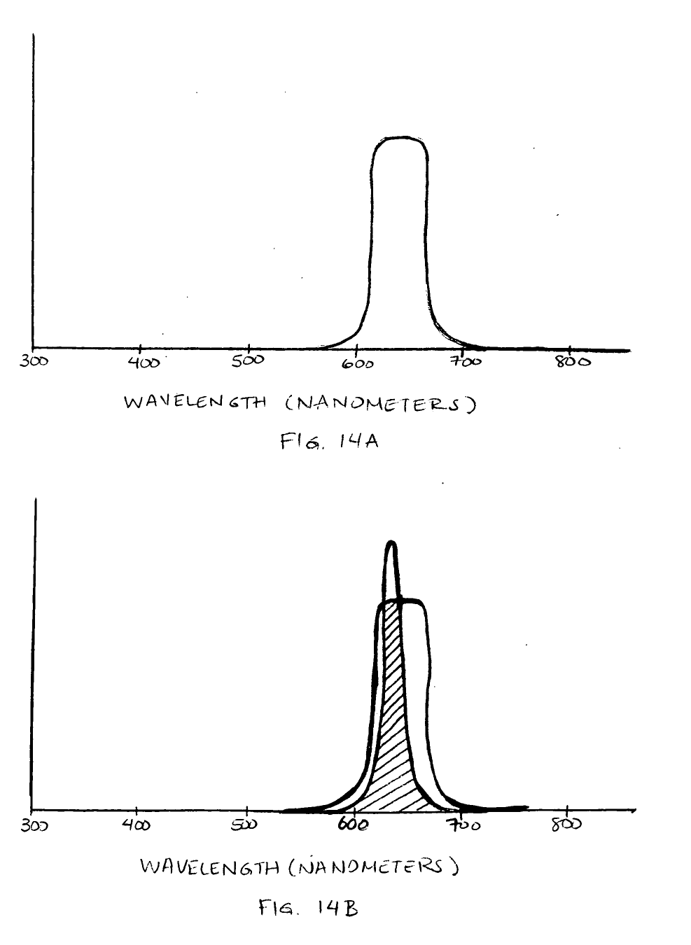

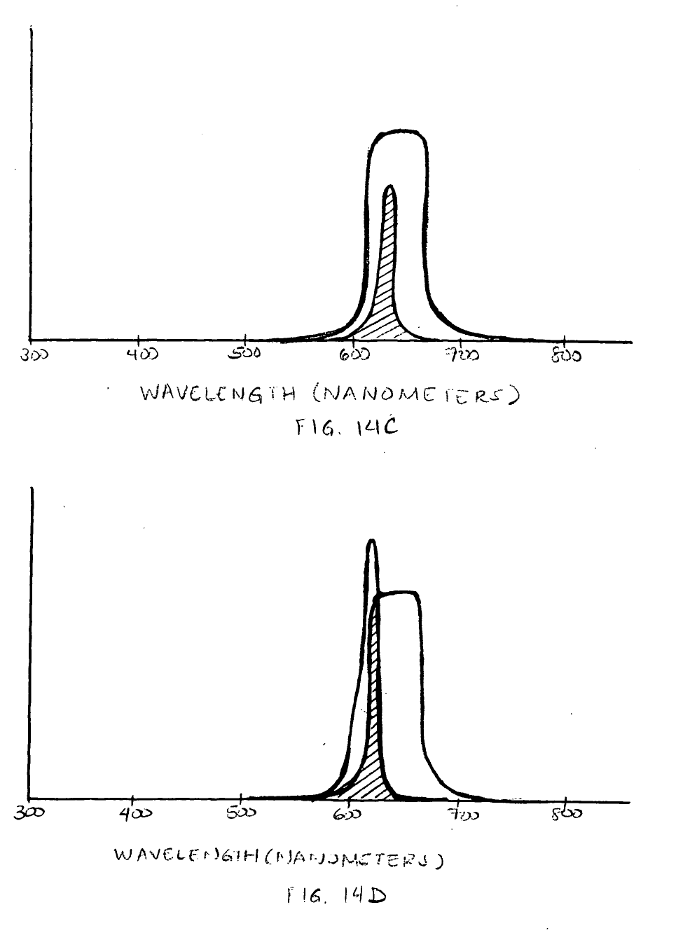

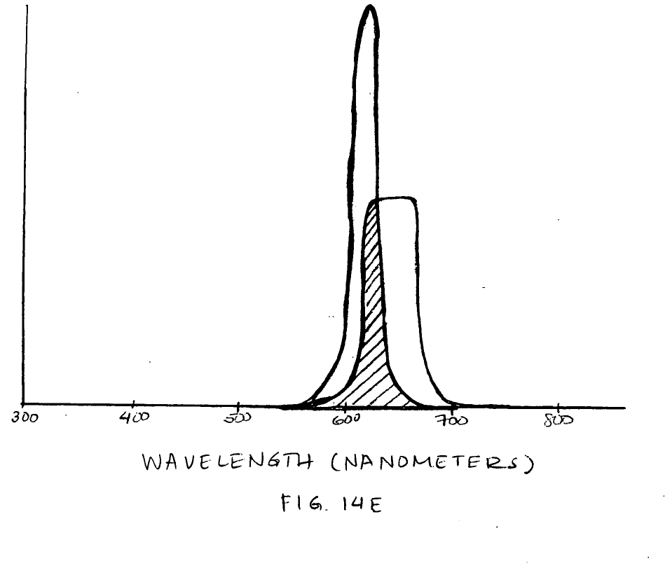

In some embodiments, a composite display comprises color pixel elements, such as red, green, and blue LEDs. In such cases, red-sensitive, green-sensitive, and blue-sensitive photodetectors may be employed to help detect color shifts in the corresponding color LEDs. For example, a red-sensitive photodetector may be employed to measure the intensity or luminance of a red LED. In order to detect red light and filter out other colors, the pass band of a red-sensitive photodetector covers wavelengths associated with red LEDs. FIG. 14A illustrates an example of a pass band of a red-sensitive photodetector. FIG. 14B illustrates both the pass band of the red-sensitive photodetector of FIG. 14A and the spectral profile of the red LED of FIG. 12B. In some embodiments, the luminance of the red LED is determined from the shaded area of FIG. 14B, i.e., the portion of the spectral profile of the red LED captured by the photodetector. FIG. 14C illustrates an example of the spectral profile of a red LED that has experienced degradation in luminance and the pass band of the red-sensitive photodetector. As depicted, a smaller area is captured by the photodetector in FIG. 14C relative to the area of FIG. 14B. The degradation in luminance detected by the red-sensitive photodetector in FIG. 14C can similarly be detected using a broadband photodetector as described above with respect to FIG. 12D. FIG. 14D illustrates an example of a color coordinate shift of the red LED and the pass band of the red-sensitive photodetector. As depicted, the peak wavelength of the red LED has drifted from 635 nm to 620 nm, i.e., towards green. Like in FIG. 14C, a smaller area is captured by the red-sensitive photodetector in FIG. 14D relative to the area of FIG. 14B. The color coordinate shift of FIG. 14D, however, would not have been detectable using only a broadband photodetector since due to its all pass nature an area similar to that in FIG. 12C would be captured even though the spectrum has shifted.

Assuming that the shaded area in FIG. 14C and the shaded area in FIG. 14D are equal, the same luminance value would be detected by the red-sensitive photodetector in both cases. A luminance value detected by the red-sensitive photodetector can be compared to a baseline value determined at manufacturing or during set-up so that reductions in luminance can be identified. A lower luminance measurement in the case of FIG. 14C results from the red LED becoming dimmer, and a lower luminance measurement in the case of FIG. 14D results from a shift in the peak wavelength of the red LED and as a result the red-sensitive photodetector only capturing the tail end of the spectrum of the red LED. An identified reduction in luminance can be corrected by increasing the current driving an LED so that the luminance of the LED can be restored to its baseline value. In the case of FIG. 14C, increasing the current driving the red LED until a baseline luminance value is measured results in restoring the luminance of the red LED to its baseline value, e.g., as depicted in FIG. 14B. In the case of FIG. 14D, increasing the current driving the red LED until a baseline luminance value is measured results in the red LED being considerably overdriven as depicted in FIG. 14E since the red-sensitive photodetector is only capturing the tail end of the spectrum of the red LED due to its color coordinate shift.

In some embodiments, red-sensitive, green-sensitive, and blue-sensitive photodetectors are included in a color composite display to aid in the calibration of red, green, and blue LEDs, respectively. In the case of a color composite display comprising red, green, and blue LEDs, overdriving one or more of the LEDs may shift the hue or chromaticity of white light, which results from simultaneously activating the red, green, and blue LEDs associated with rendering a particular temporal pixel (and/or a set or ring of temporal pixels) in the display. In such cases, white may no longer appear to be white. For example, in a composite display including a red, green, and blue LED for each temporal pixel, if the red LED has drifted towards green and is overdriven such as depicted in FIG. 14E while the blue and green LEDs do not need to be and as a result are not adjusted, the white (which would be rendered by activating all three color LEDs) would have a slightly green tinge. Thus, in such cases, there may be a need to identify a color coordinate shift in a particular color LED and/or to identify a shift in the chromaticity of white. Each of the red-sensitive, green-sensitive, and blue-sensitive photodetectors merely aids in determining a change (e.g., a decrease) in luminance and can not distinguish between a change in luminance that results from a change in brightness (e.g., the situation of FIG. 14C) and a change in luminance that results from a shift in the peak wavelength of the LED (e.g., the situation of FIG. 14D). In some embodiments, in addition to individual color photodetectors, broadband or white-sensitive photodetectors are also employed. If one or more of the color LEDs are overdriven, the luminance of white will be much higher than a baseline value measured and recorded during an initial calibration of the composite display, e.g., during manufacturing or set-up. In such cases, the currents of the color LEDs adjusted during a calibration process can be individually tweaked up and down while measuring the luminance of white to identify which color LED(s) is/are contributing to the increase in luminance of the white from its baseline value.

One or more appropriate actions may be taken to restore the chromaticity of white and/or the luminance of white to its baseline value. In some embodiments, the color that is deficient is overdriven while the color that is excessive is underdriven to remove a bias or tinge towards a particular color in the white and/or to restore the luminance of white to its baseline value. In the described example of the red LED drifting towards green, for instance, the green LED can be underdriven to balance the overdriving of the red LED. In some embodiments, the color map of the display may be redefined either globally or locally to account for changes in the wavelengths of the primaries over time. Initially when the image pixels of a particular source image are mapped to temporal pixels, a color mapping is defined that maps the colors of the source image into the available color space of the display. If one or more color coordinate shifts are found to have occurred during a calibration process, in some embodiments, the color mapping of the entire display may be redefined to a color space corresponding to the smallest color gamut available in the display for a temporal pixel. In some cases, such a global color remapping may not be necessary, and it may be sufficient to locally redefine the color mapping for the temporal pixels that are rendered by the LEDs that have experienced color coordinate shifts. Such a local remapping may be sufficient because it is difficult for the eye to perceive slight changes in color. For example, it may be difficult for the eye to perceive the difference in a red temporal pixel rendered by a red LED with a peak wavelength of 635 nm and a red temporal pixel rendered by a red LED with a peak wavelength of 620 nm, especially when the area associated with each temporal pixel is very small.

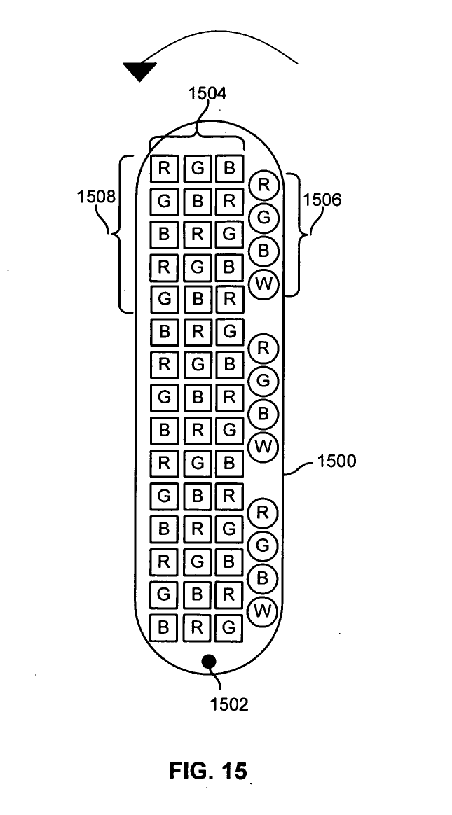

FIG. 15 illustrates an embodiment of a paddle of a composite display. Paddle 1500 is configured to rotate about axis of rotation 1502 and sweep out a circular sweep area. For example, paddle 1500 is similar to paddle 102 of FIG. 1, paddle 222 of FIG. 2B, paddles 302 and 312 of FIG. 3, and/or paddles 426 and 428 of FIG. 4B. Alternating red (R), green (G), and blue (B) LEDs are mounted along the length of paddle 1500 and in the given example are depicted by small squares. Each row of red, green, and blue LEDs at a given radius from axis of rotation 1502, such as topmost row 1504, is associated with rendering a ring of temporal pixels associated with that radius. Red-sensitive (R), green-sensitive (G), blue-sensitive (B), and broadband or white-sensitive (W) photodetectors are also mounted on paddle 1500 and in the given example are depicted by small circles. In the paddle configuration of FIG. 15, calibration is performed with respect to each row of LEDs. In various embodiments, each photodetector may be associated with measuring the intensity or luminance of any number of LEDs. In the example of FIG. 15, each color-sensitive photodetector is associated with a set of five LEDs of the corresponding color, and each broadband photodetector is associated with five rows of LEDs. For example, photodetector set 1506 is associated with LED rows 1508. Each color-sensitive photodetector is associated with measuring the luminance of a corresponding color LED. For example, the red-sensitive photodetector in set 1506 is associated with measuring the luminance of each red LED in rows 1508. The broadband or white-sensitive photodetector is associated with measuring the luminance of white, e.g., when all three color LEDs of a particular row are simultaneously activated. For example, the broadband photodetector in set 1506 is associated with measuring the luminance when all of the LEDs in a particular row of rows 1508, such as row 1504, are activated. A portion of the light emitted by each LED is reflected back towards and/or otherwise received by a corresponding photodetector. The intensities or luminance values of the LEDs as measured by corresponding color-sensitive photodetectors as well as the intensities or luminance values of white measured for the rows by associated white-sensitive photodetectors depend at least in part on the distances and/or angles of the LEDs from the photodetectors. Thus, when the LEDs of paddle 1500 are initially calibrated during manufacturing or set-up, different baseline luminance values may be measured for each LED and different baseline white luminance values may be measured for each row. The baseline values are compared to measured values during subsequent calibrations, e.g., in the field.

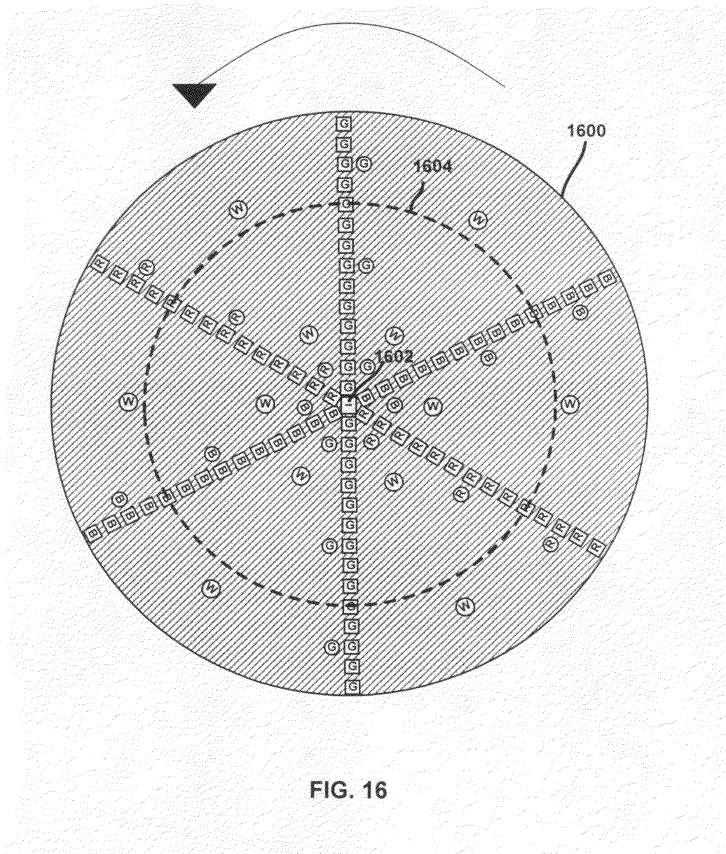

FIG. 16 illustrates an embodiment of a paddle of a composite display. Paddle 1600 comprises a PCB disc configured to rotate about axis of rotation 1602. For example, paddle 1600 is similar to paddles 432 and 438 of FIG. 4C or paddle 1100 of FIG. 11B. Alternating arrays of red (R), green (G), and blue (B) LEDs are mounted along radii of paddle 1600, and in the given example, the LEDs are depicted by small squares. In some embodiments, the LED at the center of paddle 1600 at axis of rotation 1602 comprises a tri-color RGB LED. The LEDs at a particular radius from axis of rotation 1602, such as the LEDs intersected by ring 1604, are associated with rendering the ring of temporal pixels associated with that radius. In the given example, each ring of LEDs comprises two LEDs of each primary color. Red-sensitive (R), green-sensitive (G), blue-sensitive (B), and broadband or white-sensitive (W) photodetectors are also mounted on paddle 1600 and in the given example are depicted by small circles. In the paddle configuration of FIG. 16, calibration is performed with respect to each ring of LEDs, such as ring 1604. In various embodiments, each photodetector may be associated with measuring the intensity or luminance of any number of LEDs. In the example of FIG. 16, each color-sensitive photodetector is associated with a set of four or five radially adjacent LEDs of the corresponding color, and each broadband photodetector is associated with seven rings of LEDs. In the given example, color-sensitive photodetectors are mounted close to LED arrays of the corresponding colors, and broadband photodetectors are mounted in between the LED arrays. In some embodiments, the broadband photodetectors are associated with measuring the luminance of white when all LEDs of a particular ring are simultaneously activated. A plurality of broadband photodetectors associated with a particular ring may be employed to determine the luminance of white for that ring. In some cases, an average of the luminance values measured by multiple broadband photodetectors may be employed to determine the luminance of white for a ring. Such an averaging of multiple luminance readings may be needed because the LED and broadband photodetector configuration on a paddle such as paddle 1600 may bias individual broadband photodetector luminance readings towards one or more colors. For example, a red-green, green-blue, or blue-red bias may occur in the readings of each of the broadband photodetectors of paddle 1600. Thus, to obtain the luminance of white of a ring in paddle 1600, luminance readings from two or more broadband photodetectors associated with the ring may be averaged. A portion of the light emitted by each LED is reflected back towards and/or otherwise received by a corresponding photodetector. The intensities or luminance values of the LEDs as measured by corresponding color-sensitive photodetectors as well as the intensities or luminance values of white measured for the rings by associated white-sensitive photodetectors depend at least in part on the distances and/or angles of the LEDs from the photodetectors. Thus, when the LEDs of paddle 1600 are initially calibrated during manufacturing or set-up, different baseline luminance values may be measured for each LED and different baseline white luminance values may be measured for each ring. The baseline values are compared to measured values during subsequent calibrations, e.g., in the field.

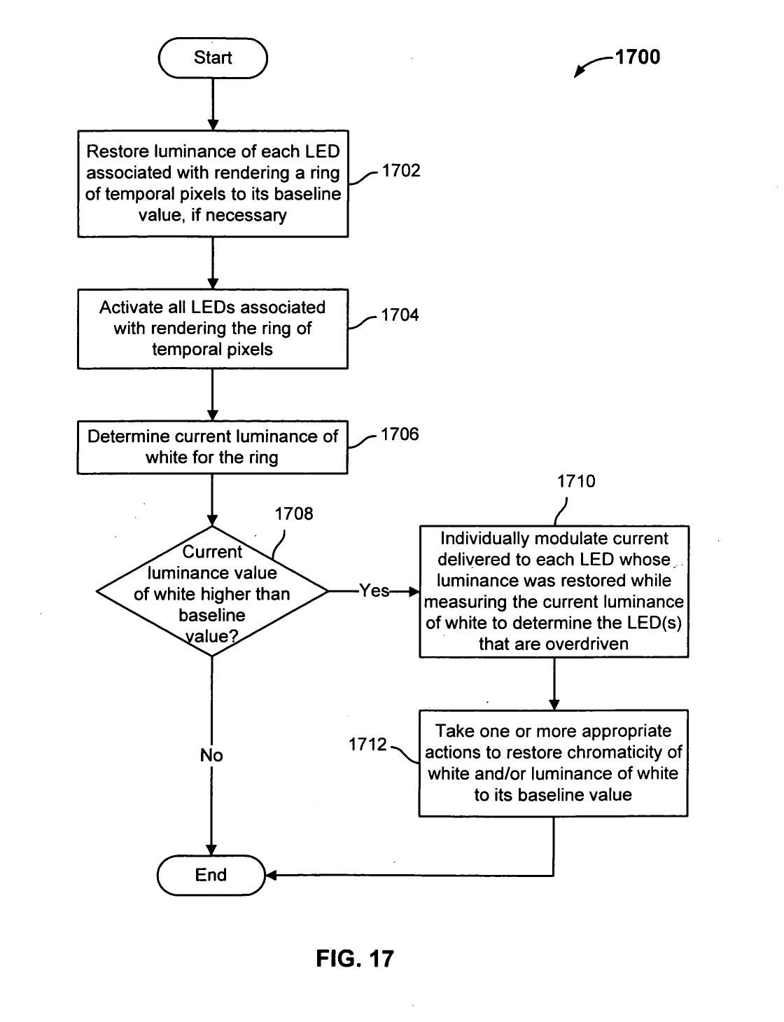

FIG. 17 illustrates an embodiment of a process for calibrating the LEDs of a paddle. In some embodiments, process 1700 is employed to correct for decreases in luminance values and/or color coordinate shifts of the LEDs which may result, for example, from aging of the LEDs. In some embodiments, process 1700 is employed to calibrate the LEDs associated with rendering each ring of temporal pixels in a composite display. For example, process 1700 may be employed to calibrate each row of LEDs, such as row 1504 in FIG. 15, or each ring of LEDs, such as ring 1604 in FIG. 16. Process 1700 starts at 1702 at which the luminance of each LED associated with rendering a particular ring of temporal pixels is restored to its baseline value, if necessary (i.e., if it has degraded). In some embodiments, process 1300 of FIG. 13 is employed at 1702 to restore the luminance of an LED. The luminance of a color LED is determined using an associated color-sensitive photodetector. At 1704, all LEDs associated with rendering the ring of temporal pixels are activated. At 1706, a current luminance of white is determined for the ring. The luminance of white is determined using one or more broadband or white-sensitive photodetectors. In some cases, the luminance of white may be determined by averaging the luminance readings of two or more broadband photodetectors. At 1708, it is determined whether the current luminance of white determined at 1706 is higher than a baseline luminance value of white, e.g., by a prescribed amount. The baseline luminance of white is determined and stored during an initial calibration of the associated composite display, e.g., during manufacturing or set-up. If it is determined at 1708 that the current luminance of white is not higher than its baseline value (e.g., by a prescribed amount), process 1700 ends. In some such cases, it may be assumed that no substantial color coordinate shift has occurred. If it is determined at 1708 that the current luminance of white is higher than its baseline value (e.g., by a prescribed amount), process 1700 proceeds to 1710. At 1710, the current delivered to each LED whose luminance was restored at 1702 is individually modulated (e.g., up and down) while measuring the current luminance of white to determine the LED(s) that are being overdriven to compensate for their color coordinate shifts, i.e., to identify the LED(s) that are causing the luminance of white to exceed its baseline value. At 1712, one or more appropriate actions are taken to restore the chromaticity of white and/or the luminance of white to its baseline value, and process 1700 subsequently ends. For example, the color towards which another color LED has shifted can be underdriven to balance the colors. In some cases, the color map of the display may be redefined based on the smallest available color gamut either globally for the entire display or locally for the LEDs associated with the ring.

Process 1700 of FIG. 17 is an example of a calibration technique. In other embodiments, any other appropriate calibration technique and/or combination of techniques may be employed. For example, another calibration technique that may be employed includes measuring the current luminance value of an LED using a broadband photodetector and comparing that value with a baseline broadband luminance value as well as measuring the current luminance value of the LED using a corresponding color-sensitive photodetector and comparing that value with a baseline color-sensitive luminance value. If the current luminance value as measured by the broadband photodetector is less than the baseline broadband luminance value by more than a prescribed amount and the current luminance value as measured by the corresponding color-sensitive photodetector is less than the baseline color-sensitive luminance value, in some embodiments, it can be concluded that the luminance of the LED has decreased, and the current delivered to the LED can be appropriately adjusted to restore the luminance. If the current luminance value as measured by the broadband photodetector is about the same as the baseline broadband luminance value or less than the baseline broadband luminance value by less than a prescribed amount and the current luminance value as measured by the corresponding color-sensitive photodetector is less than the baseline color-sensitive luminance value by a prescribed amount, in some embodiments, it can be concluded that the hue of the LED has shifted, and one or more appropriate actions to adjust for the color shift can be taken. If the current luminance value as measured by the broadband photodetector is about the same as the baseline broadband luminance value and the current luminance value as measured by the corresponding color-sensitive photodetector is about the same as the baseline color-sensitive luminance value, in some embodiments, it can be concluded that the LED has not significantly degraded, and no adjustments are needed.

The calibration techniques described herein may be employed to automatically calibrate the pixel elements of a composite display. The photodetectors installed on the paddles of a composite display allow current or real-time luminance values of the pixel elements to be measured at any given time. As described, in some embodiments, the pixel elements of a composite display are initially calibrated at manufacturing and/or set-up to obtain baseline luminance values. The pixel elements may subsequently be calibrated as desired in the field. For example, the pixel elements may be calibrated periodically. In some embodiments, the content rendered by the composite display is turned off during the calibration of the pixel elements. Turning the content off during calibration may be necessary in the cases in which the paddles need to be in prescribed positions during calibration. Calibrations in which the content needs to be turned off may be performed, for example, in the middle of the night or any other time that is permissible for turning off the content. An advantage of performing the calibrations in the middle of the night might be that sunlight, which can vary depending on time of day and weather, does not affect the measurement. In some embodiments, calibration may be performed while the composite display is rendering content. Since calibration can be performed one pixel element at a time or in parallel for a small number of pixel elements at a time, calibration can be performed while the other pixel elements of the display are rendering content. In some embodiments, the frequency domain is employed to distinguish between signals associated with calibration and signals associated with rendering content. For example, pixel elements that are being calibrated may be operated at different frequencies than the pixel elements that are rendering content. In such cases, a photodetector associated with a pixel element that is being calibrated is configured to operate at the same frequency as the pixel element. In one embodiment, pixel elements that are being calibrated are operated at high frequencies and associated photodetectors are configured to operate or sense such high frequency signals while pixel elements that are rendering content are operated at relatively lower frequencies. Calibration in the frequency domain also allows a photodetector to discriminate light emitted by the pixel element being calibrated from ambient light in the environment of the composite display. In some embodiments, each pixel element being calibrated at a given time, e.g., if multiple pixel elements are being calibrated in parallel, and its associated photodetector operate at a unique frequency so that the photodetector can discriminate the light emitted by the associated pixel element from the light emitted by other pixel elements that are being calibrated by other photodetectors, the light emitted by other pixel elements that are rendering content, and/or the ambient light. Operating photodetectors and their associated pixel elements at prescribed frequencies allows the photodetectors to filter noise from other pixel elements as well as the ambient environment of the composite display.

Calibration data, e.g., the luminance values measured by the photodetectors during calibration, may be communicated to appropriate components that process the data in any appropriate manner. For example, calibration data may be transmitted to a master controller associated with a paddle. In some embodiments, calibration data is wirelessly communicated. For example, with respect to FIG. 10, calibration data may be wirelessly communicated from paddle 1002 to paddle base 1020, which may include one or more components (e.g., integrated circuits or chips) associated with (e.g., used to control) the paddle, such as a master controller. In other embodiments, calibration data may be communicated to paddle base 1020 via optical fiber 1006. In some embodiments, if enough local logic to reset the current settings based on calibration data is included on paddle 1002, the calibration data may need not be communicated to paddle base 1020.

The light emitted by pixel elements may be captured by associated photodetectors in various manners. In some embodiments, a cover plate is installed in front of a composite display, for example, to protect the mechanical structure of the composite display and/or to prevent or reduce external interference. The cover plate may be made of any appropriate material (e.g., plastic) that is mostly transparent. A portion of the light incident on the cover plate is reflected back. For example, the material of the cover plate may reflect back 4% of incident light. In such cases, the luminance intensity of a pixel element may be measured by an associated photodetector from the portion of the light emitted by the pixel element that is reflected back from the cover plate towards the plane of the composite display and captured by the photodetector.

In some environments, such as an outdoor environment with an abundance of sunlight, a cover plate may produce an undesirable amount of reflection. In such environments, a wire mesh similar to a window screen may be used to protect the front surface of the composite display. The wire mesh may be made of any appropriate material such as stainless steel and may be appropriately colored. For example, the exterior of the wire mesh may be colored black, and the interior may have a specular, metallic finish that reflects most incident light. The aperture (i.e., amount of viewable area) of the mesh may be appropriately selected. For example, the mesh may have 96% holes and 4% wire. In the cases in which a wire mesh is used to protect the front surface of the composite display, the luminance intensity of a pixel element may be measured by an associated photodetector from the portion of the light emitted by the pixel element that is reflected back from the interior surface of the wire mesh towards the plane of the composite display and captured by the photodetector. In some embodiments, the initial calibration during manufacturing and subsequent in-field calibrations are performed with the paddles comprising the composite display in the same fixed positions since the position of a pixel element relative to the wire mesh may affect the amount of light of the pixel element that is reflected back and captured by an associated photodetector.

Any appropriate optical techniques may be employed to ensure that at least a portion of the light of a pixel element is somehow captured by an associated photodetector. In some embodiments, it may not be necessary to at least completely rely on reflection of light from a front surface of the composite display. For example, in some embodiments, a custom lenslet may be placed on a pixel element that directs or scatters a small portion (e.g., 4-5%) of the light emitted by the pixel element to the side or in the direction of an associated photodetector, and/or a custom lenslet may be placed on a photodetector to better capture light from various angles or directions. In the paddle configurations depicted in FIGS. 11A, 11B, 15, and 16, the photodetectors are mounted on the front surface of the paddle. In some embodiments, the photodetectors may be mounted on the backside of a paddle, and through-holes may be created so that the photodetectors can receive or capture light from associated pixel elements mounted on the front surface of the paddle. In such cases, for example, a custom lenslet may be attached to a pixel element that focuses a small portion of the light emitted by the pixel element through an associated through-hole so that an associated photodetector on the backside of the paddle can capture the light.

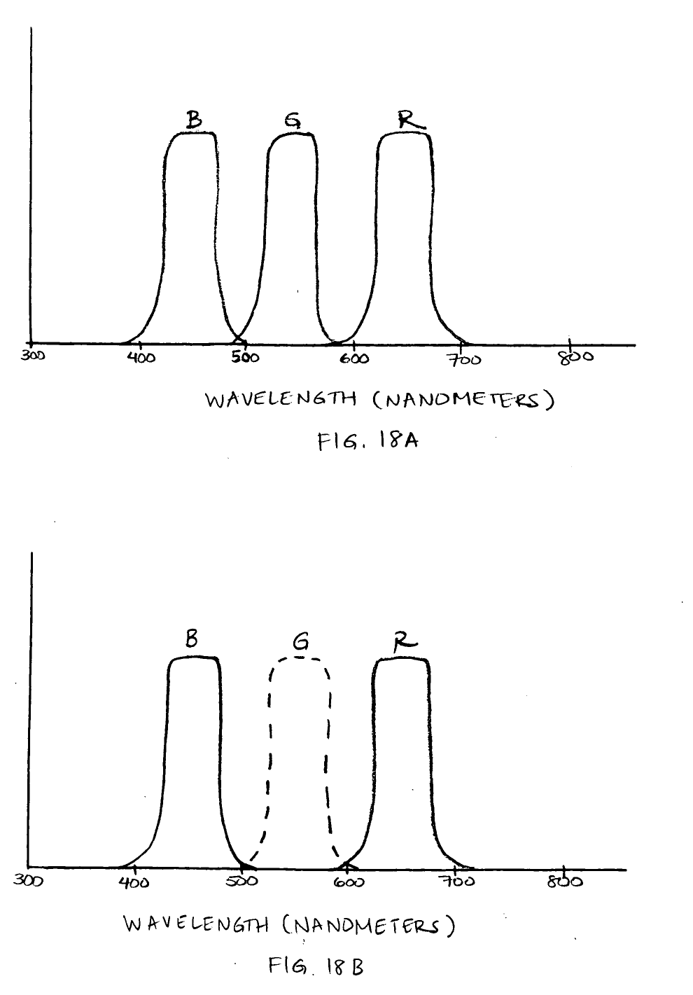

In various embodiments, different types of photodetectors may be employed. As described, in some embodiments, for a color composite display, red-sensitive, green-sensitive, blue-sensitive, and/or white-sensitive photodetectors are employed. In some embodiments, photodetectors with multiple pass bands may be employed, for example, to reduce component number and hence component cost. For example, in some embodiments, a single photodetector that is red, green, and blue-sensitive may be employed instead of separate red-sensitive, green-sensitive, and blue-sensitive photodetectors. FIG. 18A illustrates an embodiment of the triple band pass nature of such a photodetector. In some embodiments, enough separation may not exist in the pass bands of the three colors in a single photodetector that is red, green, and blue-sensitive i.e., as depicted in FIG. 18A, especially when color coordinate shifts are expected. In some such cases, for example, a photodetector that is red and blue-sensitive and a photodetector that is only green-sensitive may be employed. FIG. 18B illustrates an embodiment of the pass band of a red and blue-sensitive photodetector (solid line) and the pass band of a green-sensitive photodetector (dotted line).

As described herein, various techniques may be employed to detect and correct for luminance and/or color coordinate shifts as pixel elements degrade. Although some examples are provided herein, any appropriate techniques or combinations of techniques may be employed.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for calibrating pixel elements of a composite display, comprising:
comparing a current luminance value of white light of a temporal pixel to a baseline luminance value of white light of the temporal pixel, wherein the temporal pixel corresponds to a set of one or more pixel elements at a given sweep location; and
if the current luminance value of white light of the temporal pixel is greater than the baseline luminance value of white light of the temporal pixel by at least a prescribed amount:
concluding that at least one pixel element in the set of pixel elements has a shift in its spectrum; and
at least in part compensating for the shift in the spectrum of the at least one pixel element;
wherein each of the current luminance value of white light of the temporal pixel and the baseline luminance value of white light of the temporal pixel is determined by simultaneously activating the set of pixel elements and using one or more optical sensors associated with the set of pixel elements.

2. A method as recited in claim 1, wherein concluding that at least one pixel element in the set of pixel elements has a shift in its spectrum comprises concluding that the at least one pixel element is being overdriven.

3. A method as recited in claim 1, further comprising, for each of at least a subset of. pixel elements included in the set, restoring a current luminance value of a pixel element to a baseline luminance value associated with the pixel element if the current luminance value of the pixel element is different than the baseline luminance value of the pixel element.

4. A method as recited in claim 1, further comprising determining the current luminance value of white light of the temporal pixel.

5. A method as recited in claim 1, wherein the baseline luminance value of white light of the temporal pixel is determined during manufacturing or set-up of the composite display.

6. A method as recited in claim 1, wherein the set of pixel elements comprises one or more red, green, and blue light emitting diodes (LEDs).

7. A method as recited in claim 1, wherein the one or more optical sensors comprise one or more broadband photodetectors.

8. A method as recited in claim 1, wherein each of the current luminance value of white light of the temporal pixel and the baseline luminance value of white light of the temporal pixel is determined by averaging readings of two or more of the optical sensors.

9. A method as recited in claim 1, wherein at least in part compensating for the shift in the spectrum of the at least one pixel element comprises restoring the current luminance value of white light of the temporal pixel to the baseline luminance value of white light of the temporal pixel.

10. A method as recited in claim 1, wherein at least in part compensating for the shift in the spectrum of the at least one pixel element comprises restoring a current chromaticity of white light of the temporal pixel so that it does not include a bias towards a particular color towards which the spectrum of the at least one pixel element has shifted.

11. A method as recited in claim 1, wherein at least in part compensating for the shift in the spectrum of the at least one pixel element comprises underdriving one or more pixel elements of the set that are of a color towards which the spectrum of the at least one pixel element has shifted.

12. A method as recited in claim 1, wherein at least in part compensating for the shift in the spectrum of the at least one pixel element comprises redefining a color map of the composite display, wherein the color map maps colors from a source image to a color space of the composite display.

13. A method as recited in claim 12, wherein redefining the color map comprises locally restricting an available color space of a set of temporal pixels, including the temporal pixel, rendered by the set of pixel elements to a smallest color gamut available to any temporal pixel in the set of temporal pixels.

14. A method as recited in claim 12, wherein redefining the color map comprises globally restricting an available color space of all temporal pixels in the composite display, including the temporal pixel, to a smallest color gamut available to any temporal pixel in the composite display.

15. A method as recited in claim 1, wherein each of the current luminance value of white light of the temporal pixel and the baseline luminance value of white light of the temporal pixel is associated with a set of temporal pixels, including the temporal pixel, that is rendered by the set of pixel elements.

16. A system for calibrating pixel elements of a composite display, comprising:
a processor configured to:
compare a current luminance value of white light of a temporal pixel to a baseline luminance value of white light of the temporal pixel, wherein the temporal pixel corresponds to a set of one or more pixel elements at a given sweep location; and
if the current luminance value of white light of the temporal pixel is greater than the baseline luminance value of white light of the temporal pixel by at least a prescribed amount:
conclude that at least one pixel element in the set of pixel elements has a shift in its spectrum; and
at least in part compensate for the shift in the spectrum of the at least one pixel element; and
a memory coupled to the processor and configured to provide the processor with instructions;
wherein each of the current luminance value of white light of the temporal pixel and the baseline luminance value of white light of the temporal pixel is determined by simultaneously activating the set of pixel elements and using one or more optical sensors associated with the set of pixel elements

17. A computer program product for calibrating pixel elements of a composite display, the computer program product being embodied in a computer readable storage medium and comprising computer instructions for:
comparing a current luminance value of white light of a temporal pixel to a baseline luminance value of white light of the temporal pixel, wherein the temporal pixel corresponds to a set of one or more pixel elements at a given sweep location; and
if the current luminance value of white light of the temporal pixel is greater than the baseline luminance value of white light of the temporal pixel by at least a prescribed amount:
concluding that at least one pixel element in the set of pixel elements has a shift in its spectrum; and
at least in part compensating for the shift in the spectrum of the at least one pixel element;
wherein each of the current luminance value of white light of the temporal pixel and the baseline luminance value of white light of the temporal pixel is determined by simultaneously activating the set of pixel elements and using one or more optical sensors associated with the set of pixel elements.

18. A computer program product as recited in claim 17, wherein at least in part compensating for the shift in the spectrum of the at least one pixel element comprises restoring the current luminance value of white light of the temporal pixel to the baseline luminance value of white light of the temporal pixel.

19. A computer program product as recited in claim 17, wherein at least in part compensating for the shift in the spectrum of the at least one pixel element comprises underdriving one or more pixel elements of the set that are of a color towards which the spectrum of the at least one pixel element has shifted.

20. A computer program product as recited in claim 17, wherein at least in part compensating for the shift in the spectrum of the at least one pixel element comprises redefining a color map of the composite display, wherein the color map maps colors from a source image to a color space of the composite display.
